(19) United States
(12) Patent Application Publication
(10) Pub. No.: US 2015/0193821 A1
(43) Pub. Date: Jul. 9, 2015

(54) INFORMATION PROCESSING APPARATUS, INFORMATION PROCESSING METHOD, AND INFORMATION PROCESSING PROGRAM

(71) Applicant: Rakuten, Inc., Shinagawa-ku, Tokyo (JP)

(72) Inventors: Tatsuya Izumori, Shinagawa-ku (JP); Asami Ando, Shinagawa-ku (JP); Fumikazu Fujiwara, Shinagawa-ku (JP)

(73) Assignee: RAKUTEN, INC., Shinagawa-ku, Tokyo (JP)

(21) Appl. No.: 14/371,219

(22) PCT Filed: Sep. 28, 2012
(86) PCT No.: PCT/JP2012/075076

§ 371 Date: Jul. 9, 2014

(51) Int. Cl. G06Q 30/02

(52) U.S. Cl. CPC G06Q 30/0255; G06Q 30/0269; G06Q 30/0257; G06Q 30/0277; G06Q 30/0253

(57) ABSTRACT

An information processing apparatus acquires, from a history storage unit, the number of histories of a predetermined action of a user corresponding to acquired user identification information identifying a requesting user. The information processing apparatus acquires, from the history storage unit, user identification information of a different user who is different from the user and whose history includes page identification information included in a transmission request when the acquired number of histories of the predetermined action of the user is smaller than a threshold value. The information processing apparatus acquires a history of a predetermined action of the different user which includes user identification information of the different user from the history storage means. The information processing apparatus determines the advertisement on the basis of the acquired history of the predetermined action of the different user.

### TECHNICAL FIELD

The present invention relates to a technical field of an information processing apparatus and an information processing method which determine an advertisement to be presented to a user on the basis of histories of actions of the user.

### BACKGROUND ART

Conventionally, in a system that determines an advertisement, which is displayed on a web page, etc., for each user to whom the advertisement is provided, for example, the advertisement is determined based on histories of actions of the user to whom the advertisement is provided. For example, Patent Literature 1 discloses a technique of estimating a field of interest of a user based on browsing histories of web pages and selecting an advertisement included in an advertisement field relates to the field of interest of the user.

### CITATION LIST

### Patent Literature

Patent Literature 1: JP 2011-003155 A

### SUMMARY OF INVENTION

### Technical Problem

However, the technique described in Patent Literature 1 cannot determine an appropriate advertisement for a user for whom a sufficient number of histories are not recorded.

An object of the present invention is to provide an information processing apparatus, an information processing method, and an information processing program which can determine an appropriate advertisement for a user for whom a sufficient number of histories cannot be acquired.

### Solution to Problem

In order to solve the above problem, the invention according to claim 1 is an information processing apparatus comprising: a transmission request acquisition means that acquires a transmission request including page identification information identifying a web page being browsed and user identification information identifying a requesting user who requests a transmission of an advertisement; a number acquisition means that acquires a number of histories of a predetermined action of the user corresponding to the acquired user identification information identifying the requesting user from a history storage means storing page identification information identifying a web page at least browsed in association with user identification information identifying a user; a user identification information acquisition means that when the number of histories of the predetermined action of the user that is acquired by the number acquisition means is smaller than a threshold value, acquires user identification information of a different user who is different from the user and whose history includes the page identification information included in the transmission request from the history storage means; an action history acquisition means that acquires a history of a predetermined action of the different user, the history including user identification information of the different user from the history storage means; and an advertisement determination means that determines the advertisement on the basis of the history of the predetermined action of the different user that is acquired by the action history acquisition means.

According to the invention, when the number of histories of the requesting user is smaller than the threshold value, the different user who browsed the same web page as that browsed by the requesting user is identified and the history of the identified different user is used to determine the advertisement. Therefore, an appropriate advertisement can be determined even for a user for whom a sufficient number of histories cannot be acquired.

The invention according to claim 2 is the information processing apparatus according to claim 1, wherein the action history acquisition means acquires the histories including user identification information of a user, among the different users, whose histories a number of which is greater than or equal to a predetermined number are stored in the history storage means.

According to the invention, the histories of the different user the number of which is greater than or equal to the predetermined number are used to determine the advertisement. For a user having a certain number or more of histories, there is a probability that a tendency of interest of the user can be appropriately identified. Therefore, the advertisement is determined based on the histories of the different user whose tendency of interest can be probably identified appropriately, so that it is possible to increase a probability to be able to determine an appropriate advertisement.

The invention according to claim 3 is the information processing apparatus according to claim 1 or 2, wherein the user identification information acquisition means acquires the user identification information, from among user identification information of the different users whose histories include the page identification information included in the transmission request, corresponding to a browsing time included in a predetermined range of time from a current point in time from the history storage means storing the page identification information, the user identification information, and a browsing time of the web page in association with each other.

According to the invention, the history of the different user is used to determine the advertisement who browsed the same web page as that browsed by the requesting user within a predetermined range of time from the current point in time. Therefore, it is possible to increase a probability that the tendency of interest of different user does not change from when the different user browsed the same web page as that browsed by the requesting user, so that it is possible to increase a probability to be able to determine an appropriate advertisement.

The invention according to claim 4 is the information processing apparatus according to any one of claims 1 to 3, wherein the user identification information acquisition means acquires user identification information of the different user whose history includes the page identification information included in the transmission request and a browsing time from the history storage means storing the page identification information, the user identification information, and a browsing time of the web page in association with each other, and the action history acquisition means acquires a predetermined number of histories in order of closeness of browsing times in histories including user identification information of the different user to the browsing time acquired by the user identification information acquisition means.

According to the invention, a predetermined number of browsing histories of web page are used to determine the advertisement which are acquired in order of closeness of browsing time to the time when the same web page as that browsed by the requesting user was browsed. Therefore, a probability increases which the browsing histories used to determine the advertisement are browsing histories in a state in which the tendency of interest of the different user does not change from when the same web page as that browsed by the requesting user was browsed. Therefore, a probability increases which the browsing histories of the same tendency of interest as that of the requesting user are used to determine the advertisement, so that it is possible to increase a probability to be able to determine an appropriate advertisement.

The invention according to claim 5 is the information processing apparatus according to any one of claims 1 to 4, wherein the user identification information acquisition means acquires user identification information of the different user whose history includes the page identification information included in the transmission request and a browsing time from the history storage means storing the page identification information, the user identification information, and a browsing time of the web page in association with each other, and the action history acquisition means acquires the history including the browsing time included in a predetermined range of time from the browsing time acquired by the user identification information acquisition means from among the histories including user identification information of the different user.

According to the invention, the browsing history of web page which is used to determine the advertisement is a browsing history the browsing time of which is within a predetermined range of time from when the same web page as that browsed by the requesting user was browsed. Therefore, a probability increases which the browsing history used to determine the advertisement is a browsing history in a state in which the tendency of interest of the different user does not change from when the same web page as that browsed by the requesting user was browsed. Therefore, a probability increases which the browsing history of the same tendency of interest as that of the requesting user is used to determine the advertisement, so that it is possible to increase a probability to be able to determine an appropriate advertisement.

The invention according to claim 6 is the information processing apparatus according to any one of claims 1 to 5, wherein the user identification information acquisition means acquires user identification information of the different user whose history includes the page identification information included in the transmission request and a word from the history storage means storing the page identification information, the user identification information, and a word used when the browsed web page is searched for in association with each other, and the action history acquisition means acquires the history including the word acquired by the user identification information acquisition means from among the histories including user identification information of the different user.

According to the invention, the browsing history which is used to determine the advertisement is a browsing history of web page found by a different user who specifies the same word as that specified by the different user to search for the same web page as that browsed by the requesting user before browsing the web page. There is a probability that a plurality of web pages found by the same word are searched for and browsed by the different user having the same interest. Therefore, a probability increases which the browsing history of the same tendency of interest as that of the requesting user is used to determine the advertisement, so that it is possible to increase a probability to be able to determine an appropriate advertisement.

The invention according to claim 7 is the information processing apparatus according to any one of claims 1 to 6, wherein the advertisement determination means determines the advertisement on the basis of the histories acquired by the action history acquisition means when the number acquired by the number acquisition means is smaller than the threshold value and a number of the histories acquired by the action history acquisition means is greater than or equal to a predetermined number.

According to the invention, the number of histories of one or more different users is greater than or equal to a predetermined number, the histories of the different users are used to determine the advertisement. Therefore, there is a probability that the tendency of interest of all of the one or more different users can be appropriately identified, so that it is possible to increase a probability to be able to determine an appropriate advertisement.

The invention according to claim 8 is the information processing apparatus according to any one of claims 1 to 7, wherein the action history acquisition means acquires the histories including user identification information of different users from the history storage means storing histories including the user identification information and division identification information identifying a division to which a transaction target that is a target of the predetermined action belongs, the information processing apparatus further includes a calculation means that calculates a degree of tendency to do the predetermined action toward any of one or more divisions indicated by the division identification information included in one or more histories acquired by the action history acquisition means, and the advertisement determination means determines the advertisement on the basis of the histories acquired by the action history acquisition means when the number acquired by the number acquisition means is smaller than the threshold value and the degree of tendency that is calculated by the calculation means is greater than or equal to a second threshold value.

According to the invention, when targets of actions concentrate in a certain division of one or more divisions which are targets of actions of one or more different users, the advertisement is determined based on the histories of the different users. Therefore, when it is determined that users who browse the same web page as that browsed by the requesting user tend to be interested in a specific target, an advertisement can be determined based on the histories of different users, so that it is possible to increase a probability to be able to determine an appropriate advertisement.

The invention according to claim 9 is the information processing apparatus according to claim 8, further comprising: a second threshold value determination means that determines the second threshold value such that the smaller a number of the histories acquired by the action history acquisition means is, the smaller the second threshold value is, wherein the advertisement determination means determines the advertisement on the basis of the histories acquired by the action history acquisition means when the number acquired by the number acquisition means is smaller than the threshold value and the degree of tendency that is calculated by the calculation means is greater than or equal to the second threshold value determined by the second threshold value determination means.

According to the invention, the smaller the number of histories of the different users is, the smaller the degree of tendency by which it is determined that targets of actions concentrate in a certain division. Therefore, even when the degree of tendency is smaller than a proper degree of tendency because of a small number of browsing histories, it is possible to determine an advertisement based on the histories of the different users.

The invention according to claim 10 is the information processing apparatus according to any one of claims 1 to 9, wherein the action history acquisition means acquires histories including user identification information of the different users from the history storage means storing histories including the user identification information and division identification information identifying a division to which a transaction target that is a target of the predetermined action belongs, the information processing apparatus further includes a calculation means that calculates a degree of tendency to do the predetermined action toward any of one or more divisions indicated by the division identification information included in one or more histories acquired by the action history acquisition means, and a threshold determination means that determines the threshold value such that the larger the degree of tendency that is calculated by the calculation means is, the larger the threshold value is, and the advertisement determination means determines the advertisement on the basis of the histories acquired by the action history acquisition means when the number acquired by the number acquisition means is smaller than the threshold value determined by the threshold determination means.

According to the invention, the more the targets of actions are concentrate in a certain division, the higher the upper limit of the number of histories of the requesting user at which it is determined that the advertisement is determined based on the histories of the different users. Therefore, it is possible to increase chances for an advertisement that is appropriately determined based on the histories of different users to be transmitted.

The invention according to claim 11 is the information processing apparatus according to any one of claims 1 to 10, wherein the action history acquisition means acquires the history including user identification information of the different user from the history storage means storing the history of a user's action toward a transmitted advertisement.

According to the invention, the advertisement is determined based on the history of an action of the different user toward effects of the transmitted advertisement. There is a probability that the history of the action of the user toward the transmitted advertisement strongly indicate the tendency of interest of the user. Therefore, it is possible to increase a probability to be able to determine an appropriate advertisement.

The invention according to claim 12 is an information processing method performed by a computer, the method comprising: a transmission request acquisition step of acquiring a transmission request including page identification information identifying a web page being browsed and user identification information identifying a requesting user who requests a transmission of an advertisement; a number acquisition step of acquiring a number of histories of a predetermined action of the user corresponding to the acquired user identification information identifying the requesting user from a history storage means storing page identification information identifying a web page at least browsed in association with user identification information identifying a user; a user identification information acquisition step of when the number of histories of the predetermined action of the user that is acquired by the number acquisition step is smaller than a threshold value, acquiring user identification information of a different user who is different from the user and whose history includes the page identification information included in the transmission request from the history storage means; an action history acquisition step of acquiring a history of a predetermined action of the different user, the history including user identification information of the different user from the history storage means; and an advertisement determination step of determining the advertisement on the basis of the history of the predetermined action of the different user that is acquired in the action history acquisition step.

The invention according to claim 13 is an information processing program that causes a computer to function as: a transmission request acquisition means that acquires a transmission request including page identification information identifying a web page being browsed and user identification information identifying a requesting user who requests a transmission of an advertisement; a number acquisition means that acquires a number of histories of a predetermined action of the user corresponding to the acquired user identification information identifying the requesting user from a history storage means storing page identification information identifying a web page at least browsed in association with user identification information identifying a user; a user identification information acquisition means that when the number of histories of the predetermined action of the user that is acquired by the number acquisition means is smaller than a threshold value, acquires user identification information of a different user who is different from the user and whose history includes the page identification information included in the transmission request from the history storage means; an action history acquisition means that acquires a history of a predetermined action of the different user, the history including user identification information of the different user from the history storage means; and an advertisement determination means that determines the advertisement on the basis of the history of the predetermined action of the different user that is acquired by the action history acquisition means.

### Advantageous Effect of Invention

According to the present invention, when the number of histories of the requesting user is smaller than the threshold value, the different user who browsed the same web page as that browsed by the requesting user is identified and the history of the identified different user is used to determine the advertisement. Therefore, an appropriate advertisement can be determined even for a user for whom a sufficient number of histories cannot be acquired.

### BRIEF DESCRIPTION OF DRAWINGS

FIG. 1 is a diagram illustrating an example of a schematic configuration of an information processing system S according to an embodiment.

FIG. 2 is a sequence diagram illustrating an example of a process overview of an information processing system according to an embodiment.

FIG. 3 is a block diagram illustrating an example of a schematic configuration of an advertisement providing server 1 according to an embodiment.

FIG. 4A is a diagram illustrating an example of content registered in an advertisement DB 12a. FIG. 4B is a diagram illustrating an example of content registered in a click history DB 12b. FIG. 4C is a diagram illustrating an example of content registered in a success history DB 12c. FIG. 4D is a diagram illustrating an example of content registered in a sale item information DB 3a. FIG. 4E is a diagram illustrating an example of content registered in a browsing history 3b. FIG. 4F is a diagram illustrating an example of content registered in a member information DB 5a.

FIG. 5 is a diagram illustrating an example of functional blocks of the advertisement providing server 1 according to an embodiment.

FIG. 6 is a flowchart illustrating a process example of an advertisement transmission process of the system control unit 14 of the advertisement providing server 1 according to an embodiment.

FIG. 7 is a flowchart illustrating a process example of a different user history acquisition process of the system control unit 14 of the advertisement providing server 1 according to an embodiment.

FIG. 8A is a diagram illustrating an example of content registered in an advertisement DB 12a. FIG. 8B is a diagram illustrating an example of content registered in a browsing history DB 3b.

FIG. 9 is a diagram illustrating an example of functional blocks of the advertisement providing server 1 according to an embodiment.

FIG. 10 is a flowchart illustrating a process example of an advertisement transmission process of the system control unit 14 of the advertisement providing server 1 according to an embodiment.

FIG. 11 is a flowchart illustrating a process example of a different user history acquisition process of the system control unit 14 of the advertisement providing server 1 according to an embodiment.

FIG. 12 is a flowchart illustrating a process example of an advertisement transmission process of the system control unit 14 of the advertisement providing server 1 according to an embodiment.

### DESCRIPTION OF EMBODIMENTS

Hereinafter, embodiments of the present invention will be described in detail with reference to the drawings. The embodiments described below are embodiments where the present invention is applied to an information processing system.

### 1. First Embodiment

### 1-1. Schematic Configuration and Function of Information Processing System

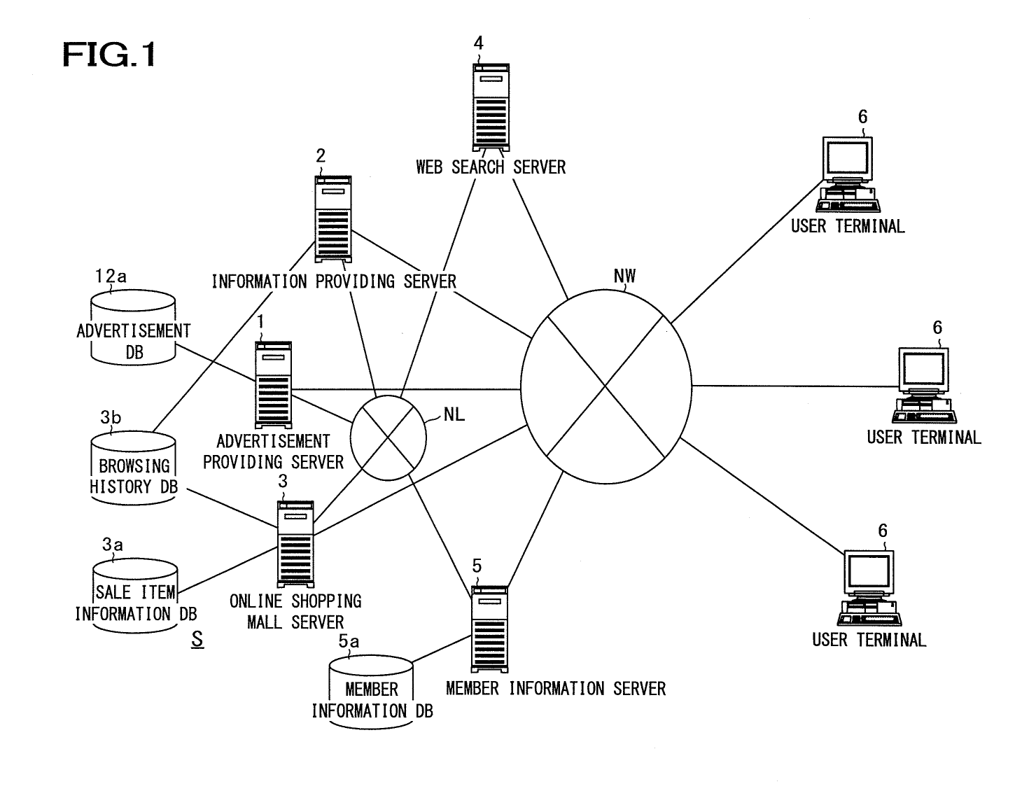

First, a configuration of an information processing system S according to the present embodiment will be described with reference to FIG. 1. FIG. 1 is a diagram illustrating an example of a schematic configuration of the information processing system S according to the present embodiment.

As illustrated in FIG. 1, the information processing system S includes an advertisement providing server 1, an information providing server 2, an online shopping mall server 3, a web search server 4, a member information server 5, and a plurality of user terminals 6. The advertisement providing server 1, the information providing server 2, the online shopping mall server 3, the web search server 4, the member information server 5, and the plurality of user terminals 6 can transmit and receive data to and from each other through a network NW by using, for example, TCP/IP as a communication protocol. The network NW includes, for example, the Internet, a dedicated communication line (for example, a CATV (Community Antenna Television) line), a mobile communication network (including a base station and the like), and a gateway.

The advertisement providing server 1, the information providing server 2, the online shopping mall server 3, the web search server 4, and the member information server 5 are a server device group that perform various processes related to a certain comprehensive site. The comprehensive site includes various websites. A user can receive various services by using the comprehensive site. The advertisement providing server 1, the information providing server 2, the online shopping mall server 3, the web search server 4, and the member information server 5 can communicate with each other through a network NL. The network NL is, for example, a dedicated network for the comprehensive site. Each server can access a data base included in another server by communicating with the server. A part of the server devices need not belong to the comprehensive site.

The advertisement providing server 1 is a server device that provides an advertisement to a user. For example, an advertisement of an item for sale sold in an online shopping mall is provided. For example, when a web page is displayed on a screen of the user terminal 3, the advertisement is displayed in the web page. A Component to display the advertisement is embedded in an HTML (HyperText Markup Language) document of the web page. The component is called an advertisement display component. The advertisement display component is described in, for example, a markup language or a script language. For example, an administrator of a website may embed an advertisement display component. Further, for example, when a website is a CGM (Consumer Generated Media), a user who provides information may embed an advertisement display component in a web page managed by the user. The advertisement providing server 1 includes an advertisement DB 12a. The “DB” is an abbreviation of database. In the advertisement DB 12a, advertisement contents are registered. The advertisement contents are data for displaying advertisements. For example, the advertisement content may be image data, moving image data, RIA (Rich Internet Application), and the like. The advertisement content may include a plurality of types of data. The advertisement providing server 1 transmits an advertisement content to the user terminal 6 according to a request from a user terminal 6 that has received a web page in which an advertisement display component is embedded. When a user selects an advertisement displayed in the web page, a sale item page of an item for sale corresponding to the advertisement is displayed on a screen of the user terminal 6. The sale item page is a web page in which detailed information of an item for sale is displayed. The sale item page exists for each item for sale sold in the online shopping mall. The user can purchase an item for sale of which information is displayed on the sale item page by selecting purchase in the sale item page.

The information providing server 2 is a server device that distributes web pages included in a website for providing information to users. The website may be any website. For example, a plurality of information providing servers 2 may be installed for each website. Advertisement display components are embedded in at least a part of the web pages provided by the information providing server 2.

The online shopping mall server 3 is a server device that performs various processes related to an online shopping mall from which items for sale can be purchased. A user can purchase a desired item for sale from a desired shop by using the online shopping mall. The item for sale is an example of a transaction target of the present invention. For example, the online shopping mall server 3 transmits a web page of the online shopping mall and performs processes related to a search and a purchase of an item for sale according to a request from the user terminal 6. For example, the online shopping mall server 3 searches for items for sale based on a search word inputted by a user. The search word is an example of a word of the present invention. The online shopping mall server 3 includes a sale item information DB 3a and a browsing history DB 3b. In the sale item information DB 3a, information of items for sale sold in the online shopping mall is registered. In the browsing history DB 3b, browsing histories of web pages provided by the information providing server 2 and browsing histories of sale item pages provided by the online shopping mall server 3 are registered. The browsing history is registered in association with a user ID of a user who browsed the page. The user ID is identification information of a user who registers with the comprehensive site as a member. The browsing history is an example of a history of a predetermined action of the present invention. The user ID is an example of user identification information of the present invention. Each of the information providing server 2 and the online shopping mall server 3 registers browsing histories in the browsing history DB 3b. The information providing server 2 may also include a browsing history DB. In the browsing history DB included in the information providing server 2, browsing histories of the web pages provided by the information providing server 2 may be registered. The information providing server 2 and the online shopping mall server 3 may be the same server device.

The web search server 4 is a server device that performs various processes related to a search site for searching for web pages. The web search server 4 has a function of a search engine. For example, the web search server 4 searches for web pages including a search word inputted by a user. Web pages that can be searched for by the web search server 4 are not limited to web pages that belong to the comprehensive site.

The member information server 5 is a server device that manages information of users who register with the comprehensive site as a member. Further, the member information server 5 performs login authentication of a user to the comprehensive site. The member information server 5 includes a member information DB 5a. In the member information DB 5a, information related to users who register with the comprehensive site as a member is registered. A user logs in to the comprehensive site by operating the user terminal 6 and inputting a user ID and a password.

During login, when the user terminal 6 transmits a request to a server device of the comprehensive site such as the information providing server 2 and the online shopping mall server 3, the user terminal 6 transmits the user ID as a cookie. Thereby, each server device can acquire the user ID from the user terminal 6. The user terminal 6 may transmit session information associated with the user ID instead of the user ID. The session information is an example of user identification information of the present invention. On the other hand, when the user does not log in, each server device cannot acquire the user ID from the user terminal 6. For example, the online shopping mall server 3 cannot acquire the user ID, so that the online shopping mall server 3 cannot register a browsing history of a sale item page in association with the user ID. In this case, the online shopping mall server 3 causes the user terminal 6 to store the browsing history of the sale item page as a cookie. It is possible to store a predetermined number of browsing histories in a cookie. For example, a cookie may be able to store up to ten browsing histories. After the user logs in, the online shopping mall server 3 registers the browsing histories included in the cookie in the browsing history DB 3b in association with the user ID.

The user terminal 6 is a terminal device of a user who uses the comprehensive site. The user terminal 6 receives a web page from a server device and displays the web page by accessing each server device based on an operation from the user. Further, the user terminal 3 receives an advertisement content from the advertisement providing server 1 and displays the advertisement by using the advertisement content. In the user terminal 6, software such as a browser and an email client is installed. For example, a personal computer, a PDA (Personal Digital Assistant), a mobile information terminal such as a smartphone, and a mobile phone are used as the user terminal 6.

### 1-2. Selection of Advertisement

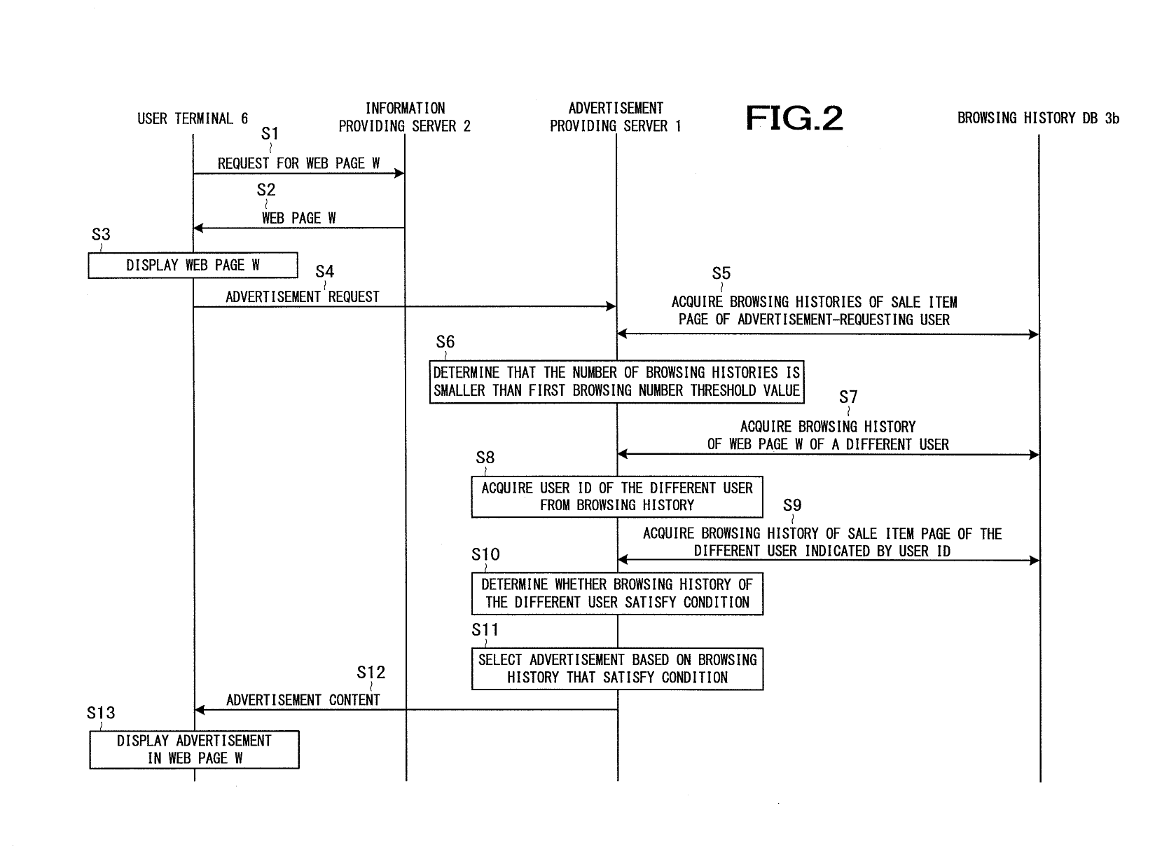

Next, a selection method of advertisement by the advertisement providing server 1 will be described with reference to FIG. 2. When the advertisement providing server 1 receives a request for an advertisement from the user terminal 6, the advertisement providing server 1 determines an advertisement provided to the user on the basis of the browsing history(ies) of sale item page of the user who uses the user terminal 6. Thereby, the advertisement providing server 1 can provide an advertisement according to an interest of the user. Therefore, it is possible to promote purchase of items for sale in the online shopping mall. The user to whom an advertisement is to be provided is referred to as an “advertisement-requesting user”. The advertisement providing server 1 can use various methods as a selection method of advertisement of the basis of the browsing history. For example, the advertisement providing server 1 may select an advertisement of an item for sale in a category where the advertisement-requesting user browsed information of item for sale most often.

However, if no browsing history of sale item page of the advertisement-requesting user is registered, the advertisement providing server 1 cannot select an advertisement. At this time, for example, it is assumed that the advertisement providing server 1 randomly select an advertisement. In this case, there is a probability that the selected advertisement does not match an interest of the advertisement-requesting user. Therefore, the effect to promote purchase of the item for sale decreases. When the number of browsing histories of sale item page of the advertisement-requesting user is small, the advertisement providing server 1 can select an advertisement. However, if the number of histories is small, the advertisement providing server 1 may not be able to appropriately identify a tendency of interest of the advertisement-requesting user.

Therefore, when the number of browsing histories of sale item page of the advertisement-requesting user is smaller than a predetermined threshold value, the advertisement providing server 1 selects an advertisement on the basis of the browsing history(ies) of sale item page of different user(s). The different user is a user other than the advertisement-requesting user. The threshold value of the number of browsing histories of sale item page is referred to as a “first browsing number threshold value”. The first browsing number threshold value is an example of a threshold value of the present invention.

FIG. 2 is a sequence diagram illustrating an example of a process overview of the information processing system according to the present embodiment. As illustrated in FIG. 2, the user terminal 6 transmits a request for a certain web page W to the information providing server 2 based on an operation of the advertisement-requesting user (step S1). In response, the information providing server 2 transmits an HTML document of the web page W to the user terminal 6 (step S2). The user terminal 6 displays the web page W based on the received HTML document (step S3).

When the HTML document of the web page W includes an advertisement display component, the user terminal 6 transmits an advertisement request to the advertisement providing server 1 (step S4). The advertisement request is a message indicating a request for transmission of advertisement. The advertisement request includes the user ID of the advertisement-requesting user as a cookie and identification information of the web page W. The identification information of the web page W may be, for example, a URL (Uniform Resource Locator) of the web page W. The advertisement request is an example of a transmission request for advertisement of the present invention. The URL is an example of page identification information of the present invention. The web page in which the advertisement display component that is a base of transmission of the advertisement request from the user terminal 6 is embedded is referred to as a “target page”. In the example of FIG. 2, the web page W is the target page.

The advertisement providing server 1 which receives the advertisement request acquires the browsing histories of sale item page of the advertisement-requesting user from the browsing history DB 3b (step S5). When the advertisement-requesting user does not log in, the advertisement providing server 1 acquires the browsing histories of sale item page from the cookie transmitted from the user terminal 6 along with the advertisement request.

Next, the advertisement providing server 1 determines whether or not the number of acquired browsing histories of sale item page is smaller than the first browsing number threshold value. For example, the first browsing number threshold value is set to a value freely determined in advance by an administrator of the advertisement providing server 1. For example, the administrator may set the maximum number of browsing histories that can be registered in a cookie as the first browsing number threshold value. Alternatively the administrator may set, for example, the first browsing number threshold value to 1.

When the advertisement providing server 1 determines that the number of browsing histories is greater than or equal to the first browsing number threshold value, the advertisement providing server 1 selects an advertisement based on the acquired browsing histories of the advertisement-requesting user. On the other hand, it is assumed that the advertisement providing server 1 determines that the number of browsing histories is smaller than the first browsing number threshold value (step S6). In this case, the advertisement providing server 1 acquires browsing histories of the web page W of a different user from the browsing history DB 3b (step S7). The reason why this process is performed is to identify a user who has a tendency of interest similar to that of the advertisement-requesting user. There is a probability that the tendency of interest of the different user who has browsed the same web page as that browsed by the advertisement-requesting user is similar to the tendency of interest of the advertisement-requesting user. In other words, there is a probability that users who have browsed the same web page have the same tendency of interest.

Next, the advertisement providing server 1 acquires the user ID of the different user from the browsing histories of the web page W of the different user (step S8). Thereby, the advertisement providing server 1 identifies the different user who has probably the same tendency of interest as that of the advertisement-requesting user. If there is a plurality of identified different users, there is a probability that the different users have the same tendency of interest.

Next, the advertisement providing server 1 acquires browsing histories of sale item page of the different user for each identified different user from the browsing history DB 3b (step S9). It can be considered that the acquired browsing histories represent a comprehensive tendency of interest of the different users.

Next, the advertisement providing server 1 determines whether or not the acquired browsing histories of sale item page of the different users satisfy a predetermined condition (step S10). The determination contents will be described later.

Next, the advertisement providing server 1 selects an advertisement based on the browsing histories that satisfy the predetermined condition (step S11). The advertisement providing server 1 can use various methods as a selection method of the advertisement based on the browsing histories. For example, the advertisement providing server 1 may select an advertisement of an item for sale of which a sale item page browsed most often by the different users. The advertisement to be selected in step S11 is selected based on the comprehensive tendency of interest of the different users who probably have the same tendency of interest as that of the advertisement-requesting user. Therefore, there is a high probability that the selected advertisement matches the tendency of interest of the advertisement-requesting user.

Next, the advertisement providing server 1 acquires an advertisement content of the selected advertisement from the advertisement DB 12a. Then, the advertisement providing server 1 transmits the acquired advertisement content to the user terminal 6 (step S12). The user terminal 6 displays the advertisement in the web page W based on the acquired advertisement content (step S13). Thereby, the advertisement providing server 1 can select an appropriate advertisement for a user for whom a sufficient number of browsing histories cannot be acquired.

Even when the number of browsing histories of sale item page of the advertisement-requesting user is smaller than the first browsing number threshold value, if the number of browsing histories of sale item page of the advertisement-requesting user is greater than or equal to a threshold value different from the first browsing number threshold value, the advertisement providing server 1 may select an advertisement based on the browsing histories of sale item page of the advertisement-requesting user and select an advertisement based on the browsing histories of sale item page of the different users. When the histories of the advertisement-requesting user are registered even if the number of the histories is small, it is possible to make use of the histories of the advertisement-requesting user to select an advertisement. By using histories of the different users as supplementary ones in addition to the above histories, it is possible to present a more appropriate advertisement to the advertisement-requesting user. The threshold value at this time is referred to as a “second browsing number threshold value”. For example, the second browsing number threshold value is set to a value determined freely in advance by the administrator of the advertisement providing server 1. Basically, the second browsing number threshold value is smaller than or equal to the first browsing number threshold value. For example, the administrator may set the second browsing number threshold value to 1. When the second browsing number threshold value<the first browsing number threshold value, a plurality of advertisements may be selected. In this case, the advertisement providing server 1 may transmit the plurality of advertisements or may transmit one of the advertisements.

In order to select the advertisement to be presented to the user more appropriate, the advertisement providing server 1 can limit the browsing histories of sale item page of the different users, which are used to select the advertisement. The method of limiting the browsing histories will be described below.

### (1) Limiting the Different Users Whose Browsing Histories of Sale Item Page are to be Used

### (1-1) The Number of Browsing Histories of Sale Item Page

The greater the number of acquired browsing histories of sale item page of a certain different user is, the greater the probability that the tendency of interest of the user can be appropriately determined. Therefore, the advertisement providing server 1 counts the number of acquired browsing histories of sale item page for each of the different users. Then, the advertisement providing server 1 may use only browsing histories of sale item page of different users of which the number of browsing histories is greater than or equal to the threshold value to select the advertisement. The threshold value at this time is referred to as a “third browsing number threshold value”. For example, the third browsing number threshold value is set to a value determined freely in advance by the administrator of the advertisement providing server 1.

### (1-2) Time of Browsing Target Page

There is a probability that a different user who has browsed a target page that has been browsed by the advertisement-requesting user has the same tendency of interest as that of the advertisement-requesting user. However, there is a case in which the time when the different user browsed the target page is away from the time when the advertisement-requesting user browses the target page. In this case, at a time around when the advertisement-requesting user browses the target page, the tendency of interest of the different user may change. Then, the tendency of interest of the different user may not match the tendency of interest of the advertisement-requesting user. Therefore, the advertisement providing server 1 may use only browsing histories of sale item page of the different users who browsed the target page during a time period between the time when the advertisement providing server 1 receives the advertisement request from the user terminal 6 and a time a predetermined time before the time when the advertisement providing server 1 receives the advertisement request to select the advertisement.

### (2) Limiting Browsing Histories of Sale Item Page of Different User

### (2-1) Relationship Between Browsing Time of Target Page and Browsing Time of Sale Item Page (No. 1).

The user may browse a plurality of web pages in the same time period. At this time, the user may have some kind of purpose and browse web pages one after another according to the purpose. Or, the user may browse the web pages one after another at will. In a case of online shopping mall, the user may compare a plurality of items for sale to purchase an item for sale by browsing a plurality of sale item pages. There is a probability that a series of web pages browsed in this case are web pages related to each other as objects of interest of the user at that time. This is the same in a relationship between a web page transmitted by the information providing server 2 and a sale item page. Therefore, the advertisement providing server 1 may use only a predetermined number of browsing histories of sale item page that are identified in order of closeness of browsing dates and times of browsing histories of the different user to the date and time when the different user browses the target page to select the advertisement. At this time, the advertisement providing server 1 may use a predetermined number of browsing histories of sale item page that are identified in the order of closeness of the browsing dates and times regardless of before and after the browsing date and time of the target page. Or, the advertisement providing server 1 may use a predetermined number of browsing histories of sale item page that are identified in the order of closeness of the browsing dates and times for each of before and after the browsing date and time of the target page, or for either before and after the browsing date and time of the target page.

### (2-2) Relationship Between Browsing Time of Target Page and Browsing Time of Sale Item Page (No. 2).

The advertisement providing server 1 may use only browsing histories of sale item page browsed by the different user within a predetermined period of time before and after the date and time when the different user browsed the target page. The reason of this is the same as that in the case of (2-1) described above.

### (2-3) Search Word Specified by Different User to Search for Target Page

When a user search for a web page according to purpose or interest, the user may search for the web page on the search site. At this time, the user inputs a search word as a search condition. The user selects a desired web page from a list of search results, and thereby the web page is displayed on the user terminal 6. When the user looks for an item for sale, the user searches for the item for sale in the online shopping mall. At this time, the user inputs a search word as a search condition. The user selects a desired item for sale from a list of search results, and thereby a sale item page is displayed on the user terminal 6. There is a probability that the search word inputted as the search condition represents interest of the user when the search is performed. Therefore, a web page and a sale item page which are found by using the same search word and browsed by a user are web pages browsed by the user with the same interest. Therefore, the advertisement providing server 1 may use only browsing histories of sale item page found by using the same search word as that specified by a different user to search for the target page from among browsing histories of sale item page of the different user to select the advertisement.

The user may specify a plurality of search words as a search condition. In this case, the advertisement providing server 1 may use only browsing histories that match all the search words or may use browsing histories that match at least one search word.

### (3) Total Number of Browsing Histories of Sale Item Page of Different Users

Only when a total number of browsing histories of sale item page of all the specified different users is greater than or equal to a threshold value, the advertisement providing server 1 may select an advertisement based on the browsing histories of sale item page of the different users. The reason of this is the same as that in the case of (1-1) described above. The threshold value at this time is referred to as a “fourth browsing number threshold value”. The fourth browsing number threshold value>the third browsing number threshold value. For example, the fourth browsing number threshold value is set to a value determined freely in advance by the administrator of the advertisement providing server 1. For example, the administrator may set the third browsing number threshold value to 100 and set the fourth browsing number threshold value to 10,000.

The advertisement providing server 1 may use all the methods of limiting the browsing histories described above or may use only a part of the methods. Or, the advertisement providing server 1 need not limit the browsing histories used to select the advertisement.

### 1-3. Configuration of Each Server Device

### 1-3-1. Configuration of Advertisement Providing Server

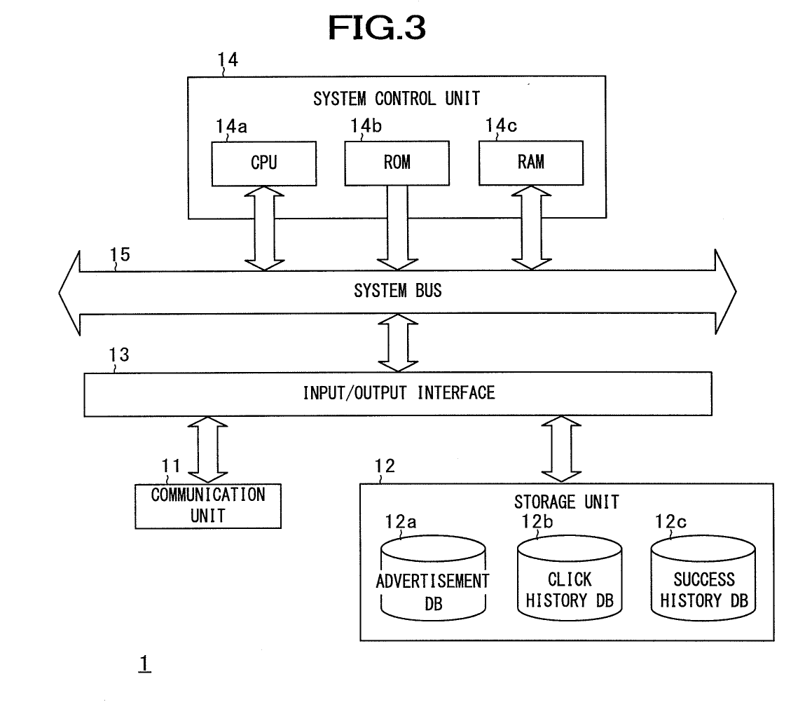

Next, a configuration of the advertisement providing server 1 will be described with reference to FIGS. 3 to 5.

FIG. 3 is a block diagram illustrating an example of a schematic configuration of the advertisement providing server 1 according to the present embodiment. As illustrated in FIG. 3, the advertisement providing server 1 includes a communication unit 11, a storage unit 12, an input/output interface 13, and a system control unit 14. The system control unit 14 and the input/output interface 13 are connected through a system bus 15.

The communication unit 11 connects to the network NW and the network NL and controls communication state with the user terminals 6 and other server devices or the like.

The storage unit 12 includes, for example, a hard disk drive and the like. The storage unit 12 is an example of a history storage means of the present invention. In the storage unit 12, databases such as an advertisement DB 12a, a click history DB 12b, and a success history DB 12c are constructed.

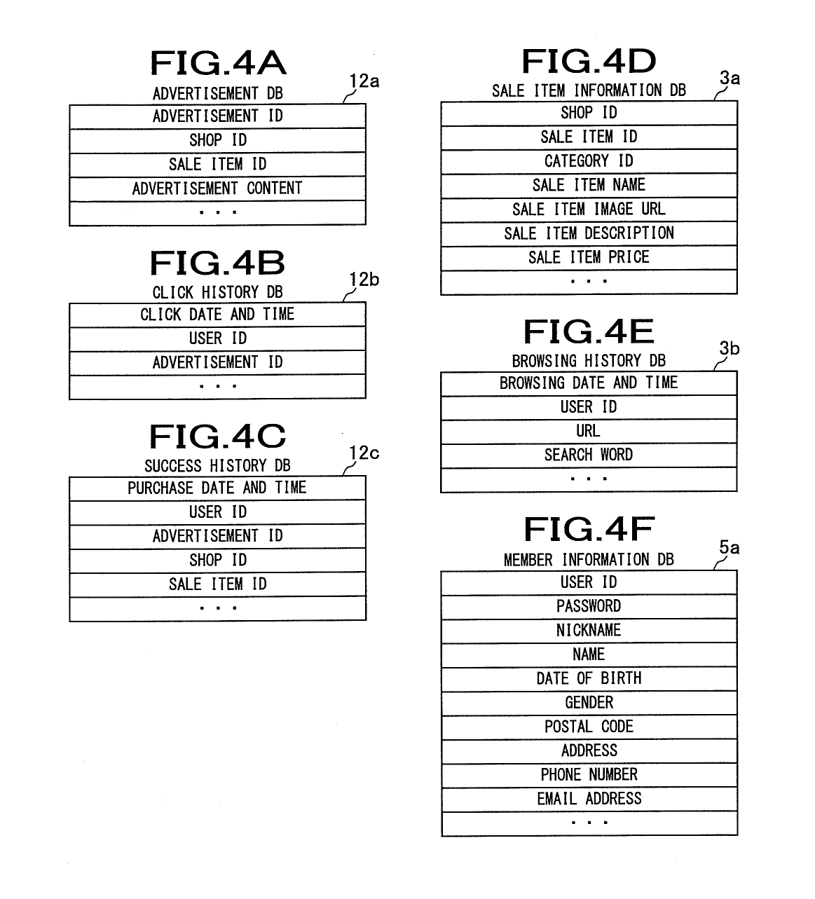

FIG. 4A is a diagram illustrating an example of content registered in the advertisement DB 12a. In the advertisement DB 12a, advertisement contents are registered. Specifically, in the advertisement DB 12a, an advertisement ID, a shop ID, a sale item ID, an advertisement content, and the like are registered in association with each other for each advertisement content. The advertisement ID is identification information of an advertisement. The shop ID is identification information of a shop which sells an item for sale corresponding to the advertisement. The sale item ID is identification information given by the shop to the item for sale corresponding to the advertisement. It is possible to uniquely identify an item for sale in the online shopping mall by a combination of the shop ID and the sale item ID.

FIG. 4B is a diagram illustrating an example of content registered in the click history DB 12b. In the click history DB 12b, a history of operations of a user to select an advertisement displayed on a web page is registered as a click history. Specifically, in the click history DB 12b, a click date and time, a user ID, an advertisement ID, and the like are registered in association with each other every time an advertisement is selected. The click date and time is a date and time at which the advertisement is selected. The user ID indicates a user who selects the advertisement. The advertisement ID indicates the selected advertisement. The fact that the user selects a displayed advertisement indicates that the user is interested in the advertisement or an item for sale corresponding to the advertisement. Therefore, the click history is an example of a history of an action of the user to a transmitted advertisement. The advertisement ID is associated with the shop ID and the sale item ID in the advertisement DB 12a. It is possible to identify a URL of a sale item page of an item for sale corresponding to an advertisement by a combination of the shop ID and the sale item ID. Therefore, the advertisement ID registered in the click history DB 12b is an example of information identifying a sale item page browsed by a user by an operation to an advertisement.

FIG. 4C is a diagram illustrating an example of content registered in the success history DB 12c. In the success history DB 12c, a history in which a user selects an advertisement and thereafter the user purchases an item for sale corresponding to the advertisement is registered as a success history. Specifically, in the success history DB 12c, a purchase date and time, a user ID, an advertisement ID, a shop ID, a sale item ID, and the like are registered every time an item for sale is purchased as a successful result of the advertisement. The purchase date and time is a date and time at which the item for sale is purchased. The user ID indicates a user who purchases the item for sale. The advertisement ID indicates an advertisement corresponding to the purchased item for sale. A combination of the shop ID and the sale item ID indicates the purchased item for sale. The success history is a history representing a successful result of the advertisement. Therefore, the success history is an example of a history of an action of the user to a transmitted advertisement. Each of the advertisement ID and the combination of the shop ID and the sale item ID registered in the click history DB 12c is an example of information identifying a sale item page browsed by a user by an operation to an advertisement.

Next, other information stored in the storage unit 12 will be described. The storage unit 12 stores various data for displaying web pages such as HTML documents, XML (Extensible Markup Language) documents, image data, text data, and electronic documents. The storage unit 12 also stores various threshold values and setting values.

Further, the storage unit 12 stores various programs such as an operating system, a WWW (World Wide Web) server program, a DBMS (Database Management System), and an advertisement management program. The advertisement management program is a program for performing various processes related to selection of advertisement and the like. The advertisement management program is an example of an information processing program of the present invention. For example, the various programs may be acquired from another server device or the like through the network NW or may be recorded in a recording medium such as a DVD (Digital Versatile Disc) and read through a drive device.

The input/output interface 13 performs interface processing among the communication unit 11, the storage unit 12, and the system control unit 14.

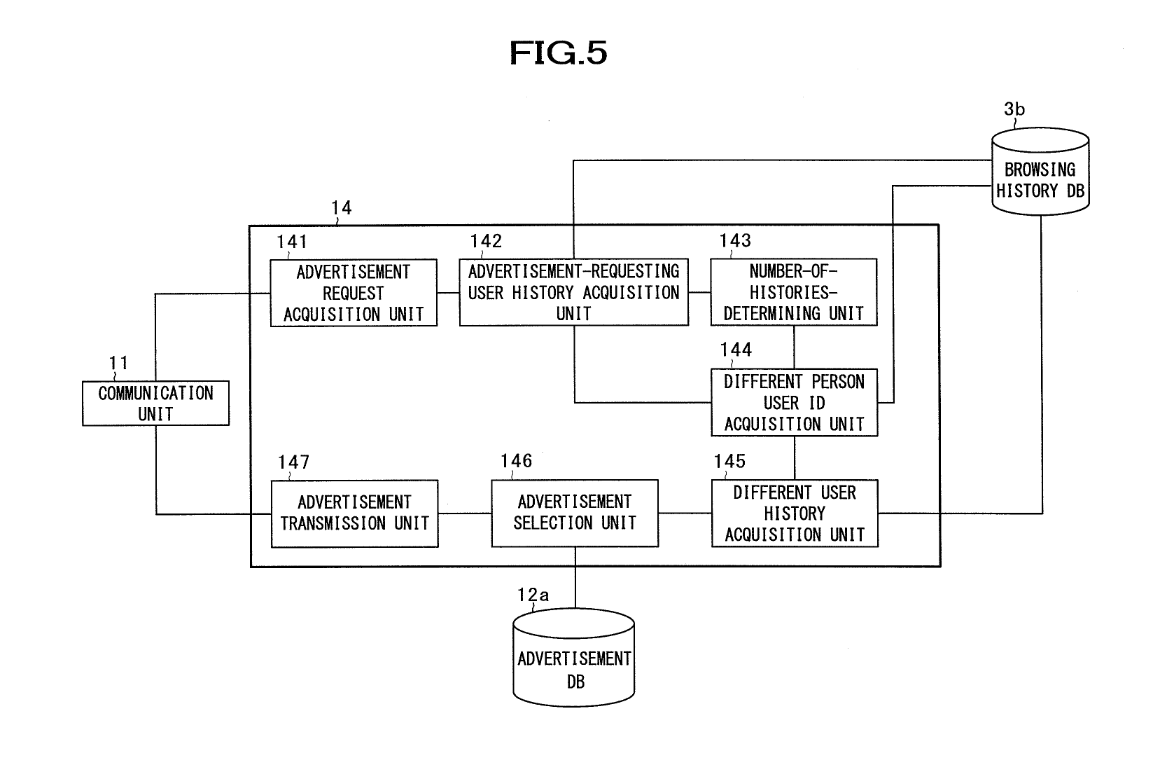

FIG. 5 is a block diagram illustrating an example of functional blocks of the advertisement providing server 1 according to the present embodiment. The system control unit 14 includes a CPU 14a, a ROM (Read Only Memory) 14b, a RAM (Random Access Memory) 14c, and the like. As illustrated in FIG. 5, in the system control unit 14, the CPU 14a reads and executes various programs, so that the system control unit 14 functions as an advertisement request acquisition unit 141, an advertisement-requesting user history acquisition unit 142, a number-of-histories-determining unit 143, a different person user ID acquisition unit 144, a different user history acquisition unit 145, an advertisement selection unit 146, and an advertisement transmission unit 147. The advertisement request acquisition unit 141 is an example of a transmission request acquisition means of the present invention. The number-of-histories-determining unit 143 is an example of a number acquisition means of the present invention. The different person user ID acquisition unit 144 is an example of a user identification information acquisition means of the present invention. The different user history acquisition unit 145 is an example of an action history acquisition means of the present invention. The advertisement selection unit 146 is an example of an advertisement determination means of the present invention.

The advertisement request acquisition unit 141 acquires an advertisement request transmitted from the user terminal 6 through the communication unit 11. The advertisement-requesting user history acquisition unit 142 acquires browsing histories in which the user ID included in the advertisement request is stored from the browsing history DB 3b. The number-of-histories-determining unit 143 acquires the number of browsing histories of sale item page of the advertisement-requesting user by counting the number of the browsing histories acquired by the advertisement-requesting user history acquisition unit 142. Then, the number-of-histories-determining unit 143 determines whether or not the number of browsing histories of sale item page of the advertisement-requesting user is smaller than the first browsing number threshold value. The different person user ID acquisition unit 144 acquires a user ID of a different user corresponding to the URL included in the advertisement request from the browsing history DB 3b. Specifically, the different person user ID acquisition unit 144 acquires a browsing history in which the URL included in the advertisement request is stored from the browsing history DB 3b. Then, the different person user ID acquisition unit 144 acquires a user ID from the acquired browsing history. The different user history acquisition unit 145 acquires browsing histories of sale item page which includes the user ID of the different user acquired by the different person user ID acquisition unit 144 from the browsing history DB 3b. At this time, the different user history acquisition unit 145 limits browsing histories to be used to select the advertisement. The advertisement selection unit 146 selects the advertisement based on the browsing histories acquired by the different user history acquisition unit 145. The advertisement transmission unit 147 transmits an advertisement content of the advertisement selected by the advertisement selection unit 146 to the user terminal 6 through the communication unit 11.

The advertisement providing server 1 may include a plurality of server devices. For example, a server device that selects the advertisement, a server device that transmits the advertisement content to the user terminal 6, a server device that manages database, and the like may be connected to each other by a LAN or the like.

### 1-3-2. Configuration of Information Providing Server, Online Shopping Mall Server, Web Search Server, and Member Information Server

Each of the information providing server 2, the online shopping mall server 3, the web search server 4, and the member information server 5 includes a control unit including a CPU or the like, a communication unit for controlling communication with the user terminals 6 and other server devices through the network NW and the network NL, and a storage unit that stores various program and data.

In the storage unit of the online shopping mall server 3, databases such as the sale item information DB 3a and the browsing history DB 3b are constructed. The storage unit of the online shopping mall server 3 is an example of a history storage means of the present invention. FIG. 4D is a diagram illustrating an example of content registered in the sale item information DB 3a. In the sale item information DB 3a, sale item information related to items for sale sold in the online shopping mall is registered. The sale item information is information registered by a shop. Specifically, in the sale item information DB 3a, a shop ID, a sale item ID, a category ID, a sale item name, a URL of a sale item image, a sale item description, a sale item price, and the like are registered in association with each other for each item for sale sold by the shop. The category ID is identification information of a category to which the item for sale belongs. In the online shopping mall, the genres of items for sale are hierarchically defined by a tree structure. As categories of the uppermost layer, for example, there are lady's fashion, personal computer and peripheral devices, food, etc. As categories immediately below the lady's fashion, for example, there are outerwear, one-piece, tops, etc. In the sale item information DB 3a, basically, a category ID of a category of the undermost layer is registered.

FIG. 4E is a diagram illustrating an example of content registered in the browsing history DB 3b. In the browsing history DB 3b, browsing histories are registered. Specifically, in the browsing history DB 3b, a browsing date and time, a user ID, a URL, a search word, and the like are registered in association with each other. The information providing server 2 registers a browsing history every time receiving a request for web page from the user terminal 6. The online shopping mall server 3 registers a browsing history every time receiving a request for a sale item page from the user terminal 6. The browsing date and time is a date and time at which the web page was browsed. The user ID indicates a user who browsed the web page. The URL indicates the browsed web page. It is possible to determine, based on the URL, whether the browsed web page is a web page provided from the information providing server 2 or a sale item page provided from the online shopping mall server 3. It is possible to identify, based on the URL of the sale item page, a shop ID and a sale item ID of a corresponding item for sale. The search word is a search word that is specified by the user indicated by the user ID in the search site or the online shopping mall in order to search for the web page indicated by the URL.

In a browsing history included in a cookie stored in the user terminal 6, for example, a browsing date and time, a URL, and a search word are stored.

FIG. 4F is a diagram illustrating an example of content registered in the member information DB 5a. In the member information DB 5a, member information related to users who register with the comprehensive site as a member is registered. Specifically, in the member information DB 5a, user attributes such as a user ID, a password, a nickname, a name, a date of birth, a gender, a postal code, an address, a phone number, and an email address are registered in association with each other for each user.

### 1-4. Operation of Information Processing System

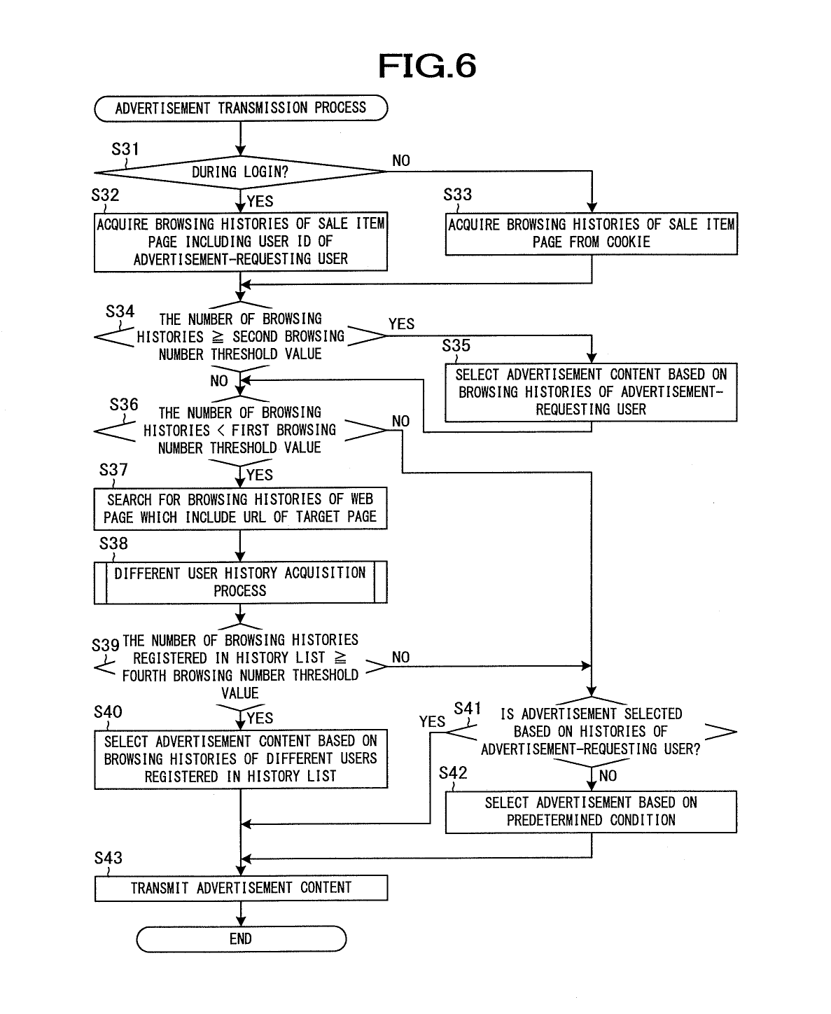

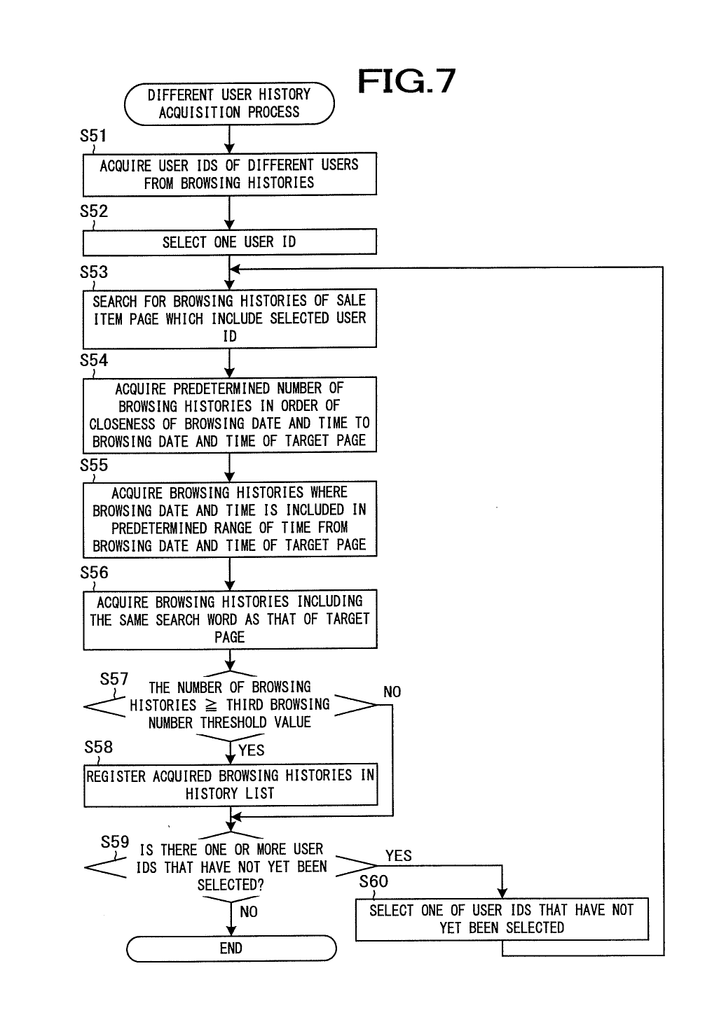

Next, operations of the information processing system S will be described with reference to FIGS. 6 and 7.

FIG. 6 is a flowchart illustrating a process example of an advertisement transmission process of the system control unit 14 of the advertisement providing server 1 according to the present embodiment. When the user terminal 6 receives an HTML document including an advertisement display component from the information providing server 2, the user terminal 6 transmits an advertisement request to the advertisement providing server 1. The advertisement request includes the URL of the target page. While the advertisement-requesting user has been logging in to the comprehensive site, the advertisement request further includes the user ID of the advertisement-requesting user. The advertisement transmission process is started when the advertisement request acquisition unit 141 receives the advertisement request.

As illustrated in FIG. 6, the advertisement-requesting user history acquisition unit 142 determines whether or not the advertisement-requesting user has been logging in (step S31). The advertisement-requesting user history acquisition unit 142 can determine whether or not the advertisement-requesting user has been logging in by checking whether the user ID is included in the advertisement request. If the advertisement-requesting user history acquisition unit 142 determines that the advertisement-requesting user has been logging in (step S31: YES), the advertisement-requesting user history acquisition unit 142 proceeds to step S32. On the other hand, if the advertisement-requesting user history acquisition unit 142 determines that the advertisement-requesting user has not been logging in (step S31: NO), the advertisement-requesting user history acquisition unit 142 proceeds to step S33.

In step S32, the advertisement-requesting user history acquisition unit 142 acquires browsing histories of sale item page of the advertisement-requesting user. Specifically, the advertisement-requesting user history acquisition unit 142 searches for and acquires the browsing histories of sale item page including the user ID included in the advertisement request from the browsing history DB 3b. Next, the advertisement-requesting user history acquisition unit 142 proceeds to step S34. In step S33, the advertisement-requesting user history acquisition unit 142 acquires the browsing histories of sale item page of the advertisement-requesting user from the cookie included in the advertisement request. Or, the advertisement-requesting user history acquisition unit 142 may acquire the browsing histories of sale item page of the advertisement-requesting user from the browsing history DB 3b based on the cookie included in the advertisement request. For example, this is a case in which identification information that identifies browsing histories is registered in the cookie and entities of the browsing histories are registered in the browsing history DB 3b in association with the identification information. Next, the advertisement-requesting user history acquisition unit 142 proceeds to step S34.

In step S34, the number-of-histories-determining unit 143 determines whether or not the number of the acquired browsing histories is greater than or equal to the second browsing number threshold value. At this time, if the number-of-histories-determining unit 143 determines that the number of the browsing histories is greater than or equal to the second browsing number threshold value (step S34: YES), the number-of-histories-determining unit 143 proceeds to step S35. On the other hand, if the number-of-histories-determining unit 143 determines that the number of the browsing histories is smaller than the second browsing number threshold value (step S34: NO), the number-of-histories-determining unit 143 proceeds to step S36.

In step S35, the advertisement selection unit 146 selects an advertisement based on the acquired browsing histories of sale item page of the advertisement-requesting user. Next, the advertisement selection unit 146 proceeds to step S36.

In step S36, the number-of-histories-determining unit 143 determines whether or not the number of the acquired browsing histories is smaller than the first browsing number threshold value. At this time, if the number-of-histories-determining unit 143 determines that the number of the browsing histories is smaller than the first browsing number threshold value (step S36: YES), the number-of-histories-determining unit 143 proceeds to step S37. On the other hand, if the number-of-histories-determining unit 143 determines that the number of the browsing histories is greater than or equal to the first browsing number threshold value (step S36: NO), the number-of-histories-determining unit 143 proceeds to step S41.

In step S37, the different person user ID acquisition unit 144 acquires browsing histories of target page of different users. Specifically, the different person user ID acquisition unit 144 searches for and acquires browsing histories, from the browsing history DB 3b, where the browsing date and time is included in a predetermined range of time from the current point in time among browsing histories including the URL included in the advertisement request. Next, the different person user ID acquisition unit 144 performs a different user history acquisition process (Step S38).

FIG. 7 is a flowchart illustrating a process example of the different user history acquisition process of the system control unit 14 of the advertisement providing server 1 according to the present embodiment.

As illustrated in FIG. 7, the different person user ID acquisition unit 144 acquires a user ID from each of the acquired browsing histories of target page of different users (step S51). At this time, the different person user ID acquisition unit 144 may exclude the user ID of the advertisement-requesting user from the user IDs to be acquired. When a plurality of the same user IDs are acquired, the different person user ID acquisition unit 144 assumes the same user IDs as one user ID. Next, the different user history acquisition unit 145 selects one of the user IDs acquired from the browsing histories (step S52). Next, the different user history acquisition unit 145 searches the browsing history DB 3b for browsing histories of sale item page including the selected user ID (step S53).

Next, the different user history acquisition unit 145 compares the browsing date and time of the browsing history of target page including the selected user ID with the browsing date and time of the browsing histories of sale item page found in step S53. Then, the different user history acquisition unit 145 acquires a predetermined number of browsing histories, from among the browsing histories of sale item page found in step S53, in an order of closeness of browsing dates and times in the browsing histories of sale item page found in step S53 to the browsing date and time of the target page including the selected user ID (step S54).

Next, the different user history acquisition unit 145 acquires browsing histories of sale item page, from among the browsing histories of sale item page found in step S53, where the browsing date and time is included in a predetermined range of time before and after the browsing date and time of the target page including the selected user ID (step S55).

Next, the different user history acquisition unit 145 acquires a search word from the browsing history of the target page including the selected user ID. Then, the different user history acquisition unit 145 acquires browsing histories, from among the browsing histories of sale item page found in step S53, including a search word corresponding to the acquired search word (step S56). Then, the different user history acquisition unit 145 merges the acquisition results of browsing histories in steps S54 to S56. At this time, if there is a plurality of the same browsing histories, the different user history acquisition unit 145 assumes the same browsing histories as one browsing history.

Next, the different user history acquisition unit 145 determines whether or not the number of the merged browsing histories is greater than or equal to the third threshold value (step S57). At this time, if the different user history acquisition unit 145 determines that the number of the browsing histories is greater than or equal to the third threshold value (step S57: YES), the different user history acquisition unit 145 proceeds to step S58. On the other hand, if the different user history acquisition unit 145 determines that the number of the browsing histories is smaller than the third threshold value (step S57: NO), the different user history acquisition unit 145 proceeds to step S59.

In step S58, the different user history acquisition unit 145 registers the merged browsing histories in a history list. Next, the different user history acquisition unit 145 proceeds to step S59. The history list is a list of histories to be used to select the advertisement. For example, the history list is a list that is temporarily used. The history list may be deleted after the advertisement is selected. The history list may be stored in any place.

In step S59, the different user history acquisition unit 145 determines whether or not there is one or more user IDs that have not yet been selected among the user IDs acquired in step S51. At this time, if the different user history acquisition unit 145 determines that there is one or more user IDs that have not yet been selected (step S59: YES), the different user history acquisition unit 145 proceeds to step S60. In step S60, the different user history acquisition unit 145 selects one of the user IDs that have not yet been selected. Next, the different user history acquisition unit 145 proceeds to step S53. On the other hand, if the different user history acquisition unit 145 determines that all the user IDs have been selected (step S59: YES), the different user history acquisition unit 145 ends the different user history acquisition process.

In the example of FIG. 7, the different user history acquisition unit 145 acquires browsing histories that satisfy at least one condition of the aforementioned (2-1) to (2-3) as a method of limiting the browsing histories of sale item page of different users. However, the different user history acquisition unit 145 may acquire only browsing histories that satisfy all the conditions of the aforementioned (2-1) to (2-3).

When the different user history acquisition process ends, as illustrated in FIG. 6, the number-of-histories-determining unit 143 determines whether or not the number of browsing histories registered in the history list is greater than or equal to the fourth browsing number threshold value (step S39). At this time, if the number-of-histories-determining unit 143 determines that the number of the browsing histories is greater than or equal to the fourth browsing number threshold value (step S39: YES), the number-of-histories-determining unit 143 proceeds to step S40. On the other hand, if the number-of-histories-determining unit 143 determines that the number of the browsing histories is smaller than the fourth browsing number threshold value (step S39: NO), the number-of-histories-determining unit 143 proceeds to step S41.

In step S40, the advertisement selection unit 146 selects an advertisement content based on the browsing histories of different users which have been registered in the history list. For example, the advertisement selection unit 146 may acquire combinations of a shop ID and a sale item ID from the browsing histories registered in the history list and select an advertisement corresponding to an item for sale indicated by combinations of certain shop ID and sale item ID the number of which is the largest. Next, the advertisement selection unit 146 proceeds to step S43.

In step S41, the advertisement selection unit 146 determines whether or not the advertisement content is selected based on the browsing histories of sale item page of the advertisement-requesting user. In other words, the advertisement selection unit 146 determines whether or not step S35 is performed. At this time, if the advertisement selection unit 146 determines that the advertisement content is selected (step S41: YES), the advertisement selection unit 146 proceeds to step S43. On the other hand, if the advertisement selection unit 146 determines that the advertisement content is not selected (step S41: NO), the advertisement selection unit 146 proceeds to step S42. In step S42, the advertisement selection unit 146 selects an advertisement based on a predetermined condition. For example, the advertisement selection unit 146 may randomly select an advertisement. Next, the advertisement selection unit 146 proceeds to step S43.

In step S43, the advertisement transmission unit 147 acquires an advertisement content of the selected advertisement from the advertisement DB 12a and transmits the advertisement content to the user terminal 6. Then, the advertisement transmission unit 147 ends the advertisement transmission process.

### 1-5. Modified Example

The advertisement providing server 1 may select an advertisement based on click histories or success histories (purchase histories) as histories of a predetermined action of different users. In this case, in step S53 of the different user history acquisition process illustrated in FIG. 7, the system control unit 14 searches for click histories or success histories that include the selected user ID. The system control unit 14 need not perform steps S54 to S56.

The advertisement providing server 1 may acquire click histories or success histories as histories of a predetermined action of the advertisement-requesting user. In this case, in step S32 of the advertisement transmission process illustrated in FIG. 6, the system control unit 14 acquires click histories or success histories that include the user ID included in the advertisement request.

When the click histories or the success histories are used, the setting values related to the number of histories such as the first to the fourth browsing number threshold values may be different from the setting values used when the browsing histories are used.

As described above, according to the present embodiment, the system control unit 14 acquires the advertisement request including the URL of the browsed web page and the user ID of the advertisement-requesting user, acquires the number of histories of a predetermined action of the user corresponding to the user ID included in the acquired advertisement request from the browsing history DB 3b constructed in the storage unit of the online shopping mall server 3 which stores URL of a web page at least browsed in association with the user ID, when the acquired number of histories of the advertisement-requesting user is smaller than the first browsing number threshold value, acquires a user ID of a different user, different from the advertisement-requesting user, of which history includes the URL included in the advertisement request from the browsing history DB 3b, acquires history including the user ID of the different user from the browsing history DB 3b, and determines an advertisement based on the acquired history of the different user. Therefore, the advertisement is determined based on the history of a different user who probably has the same tendency of interest as that of the advertisement-requesting user, so that it is possible to determine an appropriate advertisement for a user for whom a sufficient number of browsing histories cannot be acquired.

Further, the system control unit 14 acquires the browsing histories of sale item page including a user ID of a user, among different users, whose number of browsing histories of sale item page stored in the browsing history DB 3b is greater than or equal to the third browsing number threshold value. Therefore, the advertisement is determined based on the histories of a different user whose tendency of interest can be probably identified appropriately, so that it is possible to increase a probability to be able to determine an appropriate advertisement.

Further, the system control unit 14 acquires a user ID corresponding to a browsing date and time included in a predetermined range of time from the current point in time among user IDs of different users whose history includes the URL included in the advertisement request from the browsing history DB 3b that stores a URL, a user ID, and a browsing date and time of a web page in association with each other as a browsing history of the web page. Therefore, it is possible to increase a probability that the tendency of interest of a different user does not change from when the different user browsed the same web page as that browsed by the advertisement-requesting user, so that it is possible to increase a probability to be able to determine an appropriate advertisement.

Further, the system control unit 14 acquires a user ID and a browsing date and time of a different user whose history includes the URL included in the advertisement request from the browsing history DB 3b that stores a URL, a user ID, and a browsing date and time of a web page in association with each other as a browsing history of the web page and acquires a predetermined number of browsing histories in order of the closeness of the browsing time to the browsing time acquired from the browsing history of the web page from among histories including the user ID of the different user. Therefore, a probability that browsing histories of sale item page of the same tendency of interest as that of the advertisement-requesting user are used to determine the advertisement increases, so that it is possible to increase a probability to be able to determine an appropriate advertisement.

Further, the system control unit 14 acquires a user ID and a browsing date and time of a different user whose history includes the URL included in the advertisement request from the browsing history DB 3b that stores a URL, a user ID, and a browsing date and time of a web page in association with each other as a browsing history of the web page and acquires a history including a browsing time included in a predetermined range of time from the browsing time acquired from the browsing history of the web page from among histories including the user ID of the different user. Therefore, a probability that a browsing history of sale item page of the same tendency of interest as that of the advertisement-requesting user is used to determine the advertisement increases, so that it is possible to increase a probability to be able to determine an appropriate advertisement.

Further, the system control unit 14 acquires a user ID and a search word of a different user whose history includes the URL included in the advertisement request from the browsing history DB 3b that stores a URL, a user ID, and a search word used to search for a browsed web page in association with each other as a browsing history of the web page and acquires browsing history including the search word acquired from the browsing history of the web page from among browsing histories including the user ID of the different user. Therefore, a probability that a browsing history of sale item page of the same tendency of interest as that of the advertisement-requesting user is used to determine the advertisement increases, so that it is possible to increase a probability to be able to determine an appropriate advertisement.

Further, when the number of browsing histories of the advertisement-requesting user is smaller than the first browsing number threshold value and the total number of histories of different users is greater than or equal to the fourth browsing number threshold value, the system control unit 14 determines the advertisement based on acquired histories of the different users. Therefore, there is a probability that the tendency of interest of all of the one or more different users can be appropriately identified, so that it is possible to increase a probability to be able to determine an appropriate advertisement.

Further, the system control unit 14 acquires a history including the user ID acquired from the browsing history of the web page from the browsing history DB 3b that stores histories of actions of a user to the transmitted advertisement. Therefore, it is possible to increase a probability to be able to determine an appropriate advertisement.

### 2. Second Embodiment

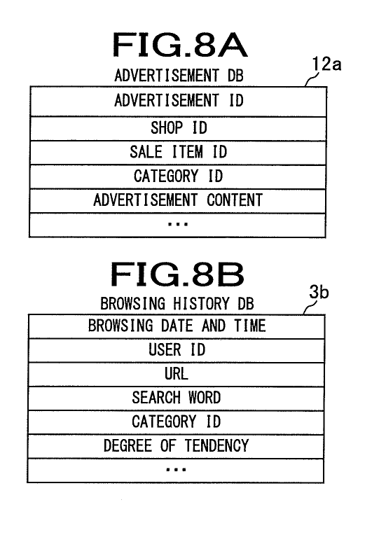

Next, a second embodiment will be described with reference to FIGS. 8 to 11. In the second embodiment, the advertisement providing server 1 selects a category based on browsing histories of different users and selects an advertisement of an item for sale belonging to the selected category. The category is an example of a division of the present invention. For example, the division may be a category, a classification, a genre, and the like.

Further, the advertisement providing server 1 calculates a degree of tendency of category of item of sale whose sale item page is browsed by different users on the basis of browsing histories of sale item page of the different users. Then, the advertisement providing server 1 determines, based on the degree of tendency, whether or not to select an advertisement based on the browsing histories of sale item page of the different users. The degree of tendency is a degree of concentration of actions in a category where the largest number of predetermined actions are performed among one or more categories where items for sale are targets of the predetermined action of users. For example, it is assumed that categories C1 to C3 are categories where sale item pages are browsed by different users among categories C1 to C10. Here, if the number of browsing times is 1,000 for each of the categories C1 to C3, the browsing is not concentrated in any of the categories C1 to C3. Therefore, the degree of tendency is the lowest. On the other hand, if the number of browsing times of sale item pages in the category C1 is 10,000 and the number of browsing times of sale item pages in each of the categories C2 and C3 is 100, the browsing is concentrated in the category C1 (users tend to browsing in the category C1). Therefore, the degree of tendency is large.

As described above, it is considered that the browsing histories of sale item page of different users represent a comprehensive tendency of interest of the different users, so that a range of interest may expand in some cases. For example, if a user is interested in the category C1, anther user is interested in the category C2, and another user is interested in the category C3, differences of the number of browsing times among the categories C1 to C3 do not appear. If there is no difference of the number of browsing times among the categories, it is difficult to select the most appropriate category from the categories C1 to C3. On the other hand, if browsing concentrates in a specific category, there is a high probability that the different users are interested in the specific category. In other words, it is estimated that users who browse the target page is interested in a category in which the browsing of sale item page is concentrated. The advertisement-requesting user is also included in the users who browse the target page. Therefore, the advertisement providing server 1 may select an advertisement of an item for sale belonging to a category in which browsing is concentrated. Therefore, the advertisement providing server 1 may calculate the degree of tendency and select an advertisement based on the browsing histories of sale item page of the different users only when the degree of tendency is greater than or equal to a threshold value. The threshold value used at this time is referred to as a “first tendency threshold value”. The first tendency threshold value is an example of a second threshold value of the present invention.

The advertisement providing server 1 may use, for example, variance or standard tendency as the degree of tendency. For example, the advertisement providing server 1 counts the number of browsing times for each category in which sale item pages are browsed by the different users based on the acquired browsing histories of sale item page of the different users. Then, the advertisement providing server 1 calculates an average value of the numbers of browsing times and calculates a difference between the number of browsing times in a category and the average value of the numbers of browsing times for each category. The advertisement providing server 1 calculates the sum of squares of the calculated differences. The larger the variance or the standard tendency is, the larger the variation of the number of browsing times is. Therefore, the larger the variance or the standard tendency is, the larger the degree of tendency to browsing in any one of the categories. In summary, the larger the variance or the standard tendency is, the larger the degree of tendency is.

The advertisement providing server 1 may use, for example, a browsing rate as the degree of tendency. For example, the advertisement providing server 1 counts the number of browsing times for each category in which sale item pages are browsed by different users. Then, the advertisement providing server 1 calculates the browsing rate of each category by dividing the number of browsing times of each category by a total number of acquired browsing histories of sale item page of the different users. The advertisement providing server 1 selects an advertisement based on the browsing histories of sale item page of the different users when the largest rate among the calculated browsing rates is greater than or equal to the first tendency threshold value. Further, the advertisement providing server 1 may use, for example, an entropy as the degree of tendency. In this case, the smaller the entropy is, the larger the degree of tendency is.

For example, the first tendency threshold value may be set to a value determined freely in advance by the administrator of the advertisement providing server 1. Or, the advertisement providing server 1 may determine the first tendency threshold value according to the number of acquired browsing histories of sale item page of the different users. It is considered that the greater the number of browsing histories is, the more the calculated degree of tendency converges to a proper value of the degree of tendency. On the other hand, if the number of browsing histories is small, the calculated degree of tendency may vary. Therefore, the advertisement providing server 1 determines the first tendency threshold value so that the greater the number of browsing histories is, the larger the first tendency threshold value is. The reason of this is that even if the degree of tendency is smaller than the proper degree of tendency because of a small number of browsing histories, an advertisement is selected based on the browsing histories of sale item page of the different users when the proper degree of tendency may be large. Therefore, the advertisement providing server 1 need not increase the first tendency threshold value when the number of browsing histories is considered to be greater than or equal to a value where the degree of tendency converges to the proper degree of tendency to some extent.

By the way, normally, a web page transmitted from the information providing server 2 is not associated with a specific category. However, the advertisement providing server 1 can associate the web page with a category by using the browsing histories of sale item page used to select an advertisement. Specifically, the advertisement providing server 1 calculates the degree of tendency by acquiring the browsing histories of sale item page of the different users and identifies a category where the number of browsing times is the greatest. There is a probability that the identified category and the calculated degree of tendency represent a comprehensive tendency of interest of the different users who browsed the target page. In other words, the identified category is a category in which the different users are most interested and the degree of tendency is a degree of interest of the different users to the identified category. Therefore, there is a probability that the target page is related to the specified category. Therefore, the advertisement providing server 1 registers the category ID of the identified category and the calculated degree of tendency in the browsing history of the target page of the advertisement-requesting user. Or, the advertisement providing server 1 may register the category ID and the degree of tendency in all browsing histories of the target page. A browsing history of web page which includes the category ID can be used to select an advertisement in the same manner as the browsing histories of sale item page. However, when the degree of tendency is low, the category associated with the target page is considered to be less relevant to the target page. Therefore, the advertisement providing server 1 may use only browsing histories where the degree of tendency is greater than or equal to a threshold value to select an advertisement. The threshold value at this time is referred to as a “second tendency threshold value”. For example, the second tendency threshold value may be set to a value determined freely in advance by the administrator of the advertisement providing server 1.

FIG. 8A is a diagram illustrating an example of content registered in the advertisement DB 12a. FIG. 8B is a diagram illustrating an example of content registered in the browsing history DB 3b. As illustrated in FIG. 8A, in the advertisement DB 12a of the present embodiment, the category ID is added to the advertisement DB 12a illustrated in FIG. 4A as information to be registered. The category ID indicates a category to which an item for sale corresponding to the advertisement belongs. As illustrated in FIG. 8B, in the browsing history DB 3b of the present embodiment, the category ID and the degree of tendency are added to the browsing history DB 3b illustrated in FIG. 4E as information to be registered. The browsing histories of web page provided by the information providing server 2 include browsing histories in which the category ID and the degree of tendency are registered and browsing histories in which the category ID and the degree of tendency are not registered. The degree of tendency is not registered in browsing histories of sale item page. In each database, a category ID of a category of a layer determined in advance by an administrator of the comprehensive site is registered. For example, the administrator determines a layer that is considered to be appropriate from among a plurality of layers of category.

In the advertisement DB 12a, the category ID need not be registered. In the browsing histories of sale item page registered in the browsing history DB 3b, the category ID need not be registered. The reason of this is that the category can be identified from the advertisement ID or the URL of the sale item page. The shop ID and the sale item ID can be identified from the advertisement ID or the URL of the sale item page. In the sale item information DB 3a, the category ID of the category in the undermost layer is associated with the shop ID and the sale item ID. The category ID of the category of the layer determined in advance by the administrator can be identified from the category ID of the category of the undermost layer. Therefore, each of the advertisement ID and the URL of the sale item page is an example of information identifying a division of the present invention.

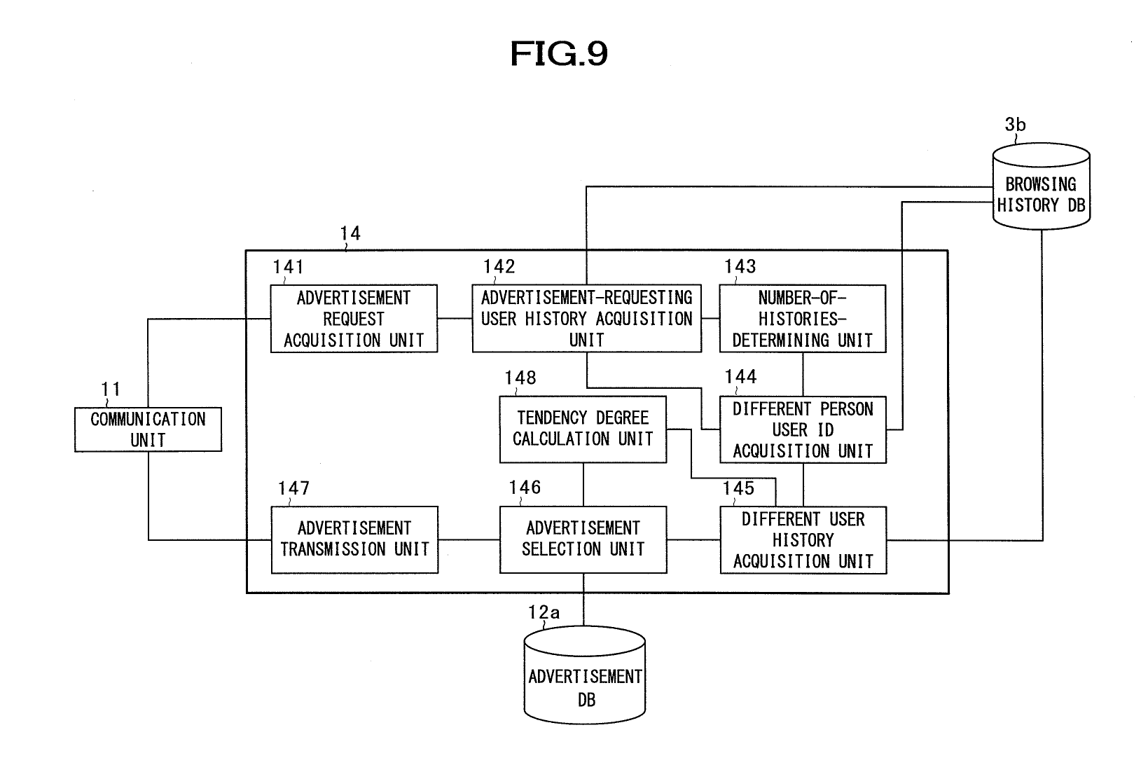

FIG. 9 is a block diagram illustrating an example of functional blocks of the advertisement providing server 1 according to the present embodiment. As illustrated in FIG. 9, in the present embodiment, a tendency degree calculation unit 148 is added as compared with the functional blocks illustrated in FIG. 5. The tendency degree calculation unit 148 is an example of a calculation means of the present invention. The tendency degree calculation unit 148 calculates the degree of tendency based on browsing histories acquired by the different user history acquisition unit 145.

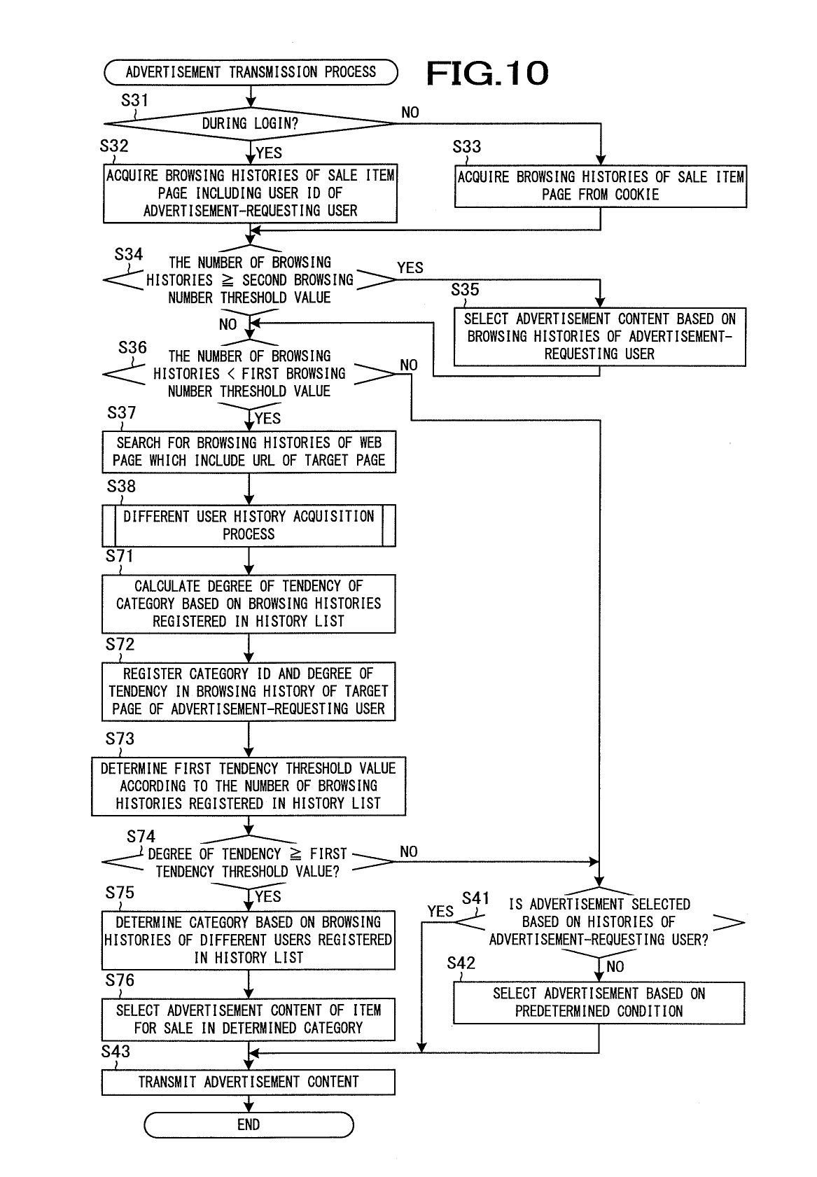

FIG. 10 is a flowchart illustrating a process example of an advertisement transmission process of the system control unit 14 of the advertisement providing server 1 according to the present embodiment. In FIG. 10, the same processes as those in FIG. 6 are denoted by the same reference numerals. As illustrated in FIG. 10, the different person user ID acquisition unit 144 performs a different user history acquisition process after steps S31 to S37. (Step S38)

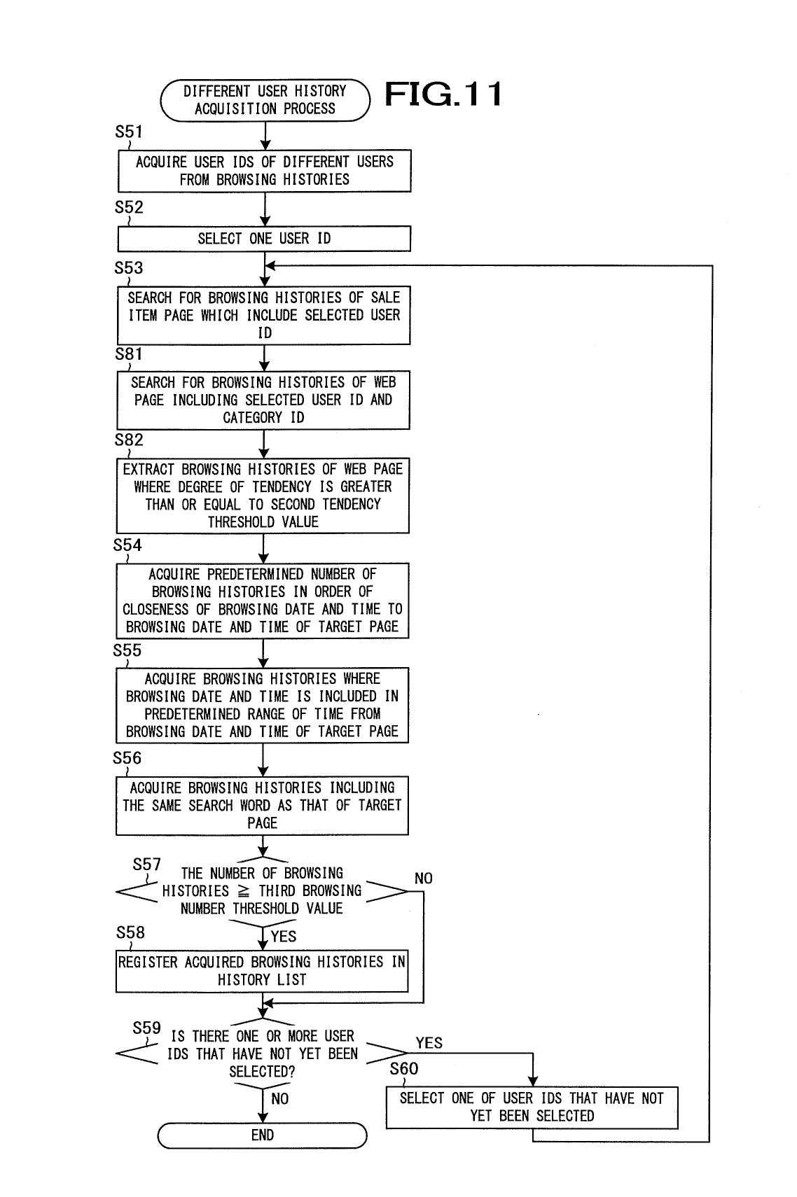

FIG. 11 is a flowchart illustrating a process example of the different user history acquisition process of the system control unit 14 of the advertisement providing server 1 according to the present embodiment. In FIG. 11, the same processes as those in FIG. 7 are denoted by the same reference numerals. As illustrated in FIG. 11, after steps S51 to S53, the different user history acquisition unit 145 searches the browsing history DB 3b for browsing histories including the selected user ID and a category ID from among browsing histories of web page provided from the information providing server (step S81). Next, the different user history acquisition unit 145 extracts browsing histories where the degree of tendency is greater than or equal to the second tendency threshold value from among the found browsing histories (step S82). Next, the different user history acquisition unit 145 performs steps S54 to S60. In steps S54 to S58, the different user history acquisition unit 145 performs processes by using the browsing histories of sale item page found in step S53 and the browsing histories of web page extracted in step S82.

When the different user history acquisition process ends, as illustrated in FIG. 10, the tendency degree calculation unit 148 calculates the degree of tendency based on the browsing histories registered in the history list (step S71). It is possible to identify a category where a sale item page or a web page is browsed from the category ID included in each browsing history. The calculation method of the degree of tendency has already been described, so a detailed description of the process is omitted.

Next, the tendency degree calculation unit 148 registers the category ID of a category where the number of browsing times is the greatest and the degree of tendency in the browsing history of the target page of the advertisement-requesting user which is registered in the browsing history DB 3b (step S72). When the information providing server 2 receives a request for the target page from the user terminal 6, the browsing history is registered in the browsing history DB 3b. Therefore, the tendency degree calculation unit 148 may register the category ID and the degree of tendency in the browsing history where the browsing date and time is the latest among the browsing histories including the user ID of the advertisement-requesting user and the URL of the target page.

Next, the tendency degree calculation unit 148 determines the first tendency threshold value according to the number of browsing histories registered in the history list (step S73). Next, the tendency degree calculation unit 148 determines whether or not the degree of tendency is greater than or equal to the first tendency threshold value (step S74). At this time, if the tendency degree calculation unit 148 determines that the degree of tendency is greater than or equal to the first tendency threshold value (step S74: YES), the tendency degree calculation unit 148 proceeds to step S75. On the other hand, if the tendency degree calculation unit 148 determines that the degree of tendency is smaller than the first tendency threshold value (step S74: NO), the tendency degree calculation unit 148 proceeds to step S41.

In step S75, the advertisement selection unit 146 determines a category based on the browsing histories registered in the history list. For example, the advertisement selection unit 146 may determine a category where the number of browsing times is the greatest. Next, the advertisement selection unit 146 selects an advertisement based on the determined category (step S176). For example, the advertisement selection unit 146 may randomly select an advertisement from among advertisements of items for sale belonging to the determined category. Next, the advertisement selection unit 146 proceeds to step S43.

### Modified Example

Also in the second embodiment, the advertisement providing server 1 may select an advertisement based on the click histories or the success histories as histories of a predetermined action of different users. When the click histories or the success histories are used, the setting values related to the number of histories such as the first to the fourth browsing number threshold values may be different from the setting values used when the browsing histories are used. In the click history 12b and the success history 12c, a category ID of a category to which a corresponding item for sale belongs may be registered. The system control unit 14 may not perform step S72 of the advertisement transmission process shown in FIG. 10. The system control unit 14 may not perform steps S81 and S82 of the different user history acquisition process shown in FIG. 11. The advertisement providing server 1 may acquire the click histories or the success histories as histories of a predetermined action of the advertisement-requesting user.

As described above, according to the present embodiment, the system control unit 14 acquires histories including a user ID of different users from the browsing history DB 3b that stores histories including a user ID and a category ID of a category to which an item for sale that is a target of a predetermined action belongs, calculates the degree of tendency of a predetermined action to one category of one or more categories indicated by category information included in one or more acquired histories, and determines an advertisement based on the acquired histories of the different users when the number of histories of the advertisement-requesting user is smaller than the first browsing number threshold value and the calculated degree of tendency is greater than or equal to the first tendency threshold value. Therefore, when it is determined that users who browse the same web page as that browsed by the advertisement-requesting user tend to be interested in a specific target, an advertisement can be determined based on the histories of different users, so that it is possible to increase a probability to be able to determine an appropriate advertisement.

Further, the system control unit 14 determines the first tendency threshold value so that the smaller the number of acquired histories of different users is, the smaller the first tendency threshold value is, and determines an advertisement based on the acquired histories of different users when the number of histories of the advertisement-requesting user is smaller than the first browsing number threshold value and the calculated degree of tendency is greater than or equal to the first tendency threshold value. Therefore, even when the degree of tendency is smaller than a proper degree of tendency because of a small number of browsing histories, it is possible to determine an advertisement based on the histories of different users.

### 3. Third Embodiment

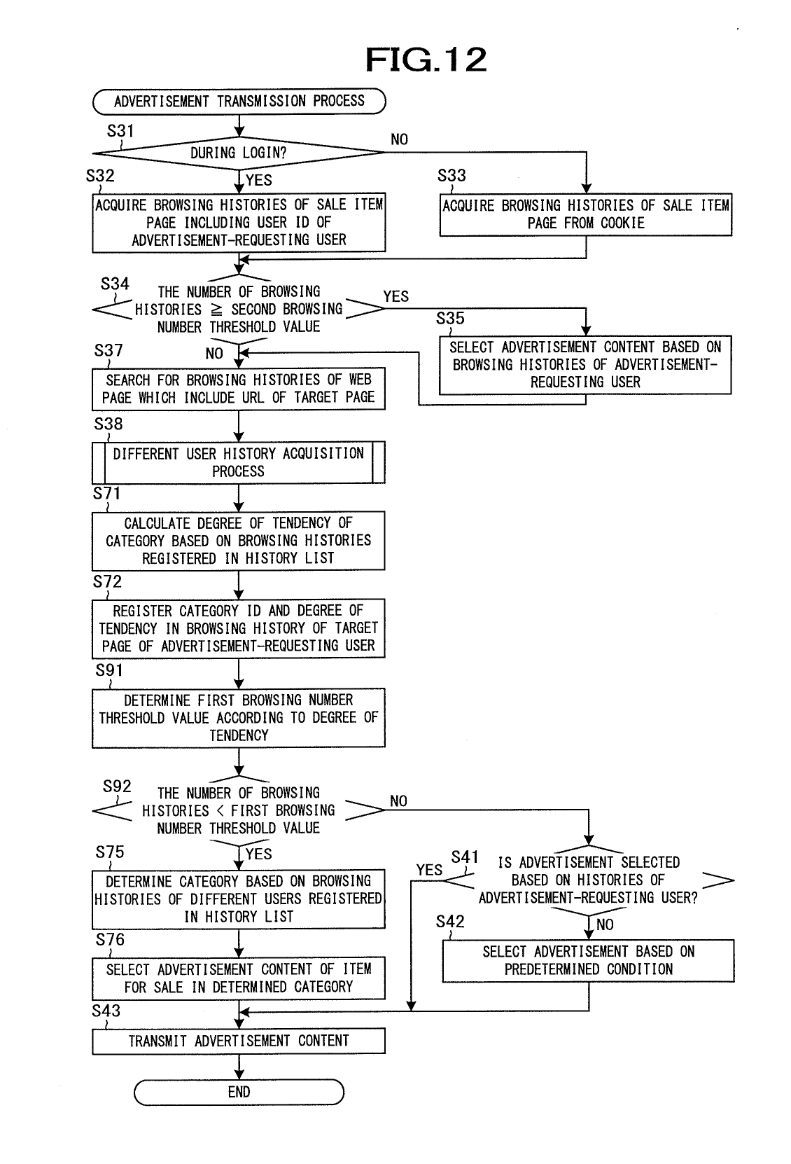

Next, a third embodiment will be described with reference to FIG. 12. In the third embodiment, the advertisement providing server 1 selects a category based on browsing histories of different users and selects an advertisement of an item for sale belonging to the selected category. Further, the advertisement providing server 1 determines the first browsing number threshold value according to the degree of tendency of category. There is a probability that the larger the degree of tendency calculated based on browsing histories of different users is, the stronger a comprehensive tendency of users to be interested in a particular thing is. It can be considered that the stronger the tendency of interest is, the higher the probability that a comprehensive tendency of interest of different users who browsed the target page matches the tendency of interest of the advertisement-requesting user. Therefore, the larger the degree of tendency of category, the larger the first browsing number threshold value the advertisement providing server 1 may set. For example, it is assumed that the first browsing number threshold value is set to 100. When the number of browsing histories of the advertisement-requesting user is 100, it can be considered that the advertisement providing server 1 selects an appropriate advertisement by using the browsing histories of the advertisement-requesting user without using browsing histories of different users. However, when the degree of tendency is large, there is a probability that an appropriate advertisement can be selected by using browsing histories of different users. If an appropriate advertisement can be selected, even when the number of browsing histories of the advertisement-requesting user is greater than 100, the advertisement providing server 1 may select an advertisement by using browsing histories of different users.

FIG. 12 is a flowchart illustrating a process example of an advertisement transmission process of the system control unit 14 of the advertisement providing server 1 according to the present embodiment. In FIG. 12, the same processes as those in FIG. 10 are denoted by the same reference numerals. As illustrated in FIG. 12, steps S31 to S35 are performed. In step S34, if it is determined that the number of browsing histories is greater than or equal to the second browsing number threshold value (step S34: YES), and after step S35, steps S37, S38, S71, and S72 are performed. If it is determined that the number of browsing histories is smaller than the second browsing number threshold value (step S34: NO), steps S37, S38, S71, and S72 are performed. The content of the different user history acquisition process is the same as that in the second embodiment.

After step S72, the number-of-histories-determining unit 143 determines the first browsing number threshold value according to the calculated degree of tendency (step S91). Next, the number-of-histories-determining unit 143 determines whether or not the number of browsing histories acquired in step S32 or S33 is smaller than the determined first browsing number threshold value (step S92). At this time, if the number-of-histories-determining unit 143 determines that the number of the browsing histories is smaller than the first browsing number threshold value (step S92: YES), the number-of-histories-determining unit 143 proceeds to step S75. Then, steps S71, S76, and S43 are performed. On the other hand, if the number-of-histories-determining unit 143 determines that the number of the browsing histories is greater than or equal to the first browsing number threshold value (step S92: NO), the number-of-histories-determining unit 143 proceeds to step S41.

Also in the third embodiment, in the same manner as in the second embodiment, the advertisement providing server 1 may select an advertisement based on the click histories or the success histories as histories of a predetermined action of different users. The advertisement providing server 1 may acquire the click histories or the success histories as histories of a predetermined action of the advertisement-requesting user. Further, it is possible to combine the second embodiment and the third embodiment.

As described above, the system control unit 14 acquires histories including a user ID of different users from the browsing history DB 3b that stores histories including a user ID and a category ID of a category to which an item for sale that is a target of a predetermined action belongs, calculates the degree of tendency of a predetermined action to one category of one or more categories indicated by a category ID included in one or more acquired histories of different users, determines the first browsing number threshold value so that the larger the calculated degree of tendency is, the larger the first browsing number threshold value is, and determines an advertisement based on the acquired histories of different users when the number of histories of the advertisement-requesting user is smaller than the first browsing number threshold value. Therefore, it is possible to increase chances for an advertisement that is appropriately determined based on the histories of different users to be transmitted.

In the embodiments described above, a history of a predetermined action of a user in the present invention is applied to the browsing history, the click history, or the success history. However, the history of the present invention can be applied to a history, of a certain action of a user, by which an advertisement suited to the user can be determined. The advertisement may be determined based on a plurality of types of histories.

The transaction target of the present invention may be applied to things other than items for sale. For example, the transaction target may be things to be an object of a commercial transaction. Therefore, the target of the advertisement is not limited to items for sale. Further, the web site where the transaction target that is the target of the advertisement is transacted is not limited to the online shopping mall. For example, the transaction target may be a service.

In the embodiments described above, the information providing server 2 belongs to the comprehensive site to which the advertisement providing server 1 belongs. However, the information providing server 2 need not belong to the comprehensive site to which the advertisement providing server 1 belongs. In this case, for example, the information providing server 2 includes a browsing history DB in which browsing histories of web pages provided by the information providing server 2 are registered. In this case, the browsing histories of web pages provided by the information providing server 2 are registered in the browsing history DB 3b by using, for example, a tool bar program. The tool bar program is installed as, for example, an add-on to expand functions of a browser. The tool bar program is, for example, a program for searching for web pages in the search site. For example, the tool bar program can be downloaded from the web search server 4. When the user terminal 3 activates a browser by an operation of a user, a tool bar is displayed in a window of the browser. When the user inputs a search word in an input field in the tool bar, the web search server 4 searches for web pages based on the search word. Then, search results of web pages are displayed in the window of the browser. When the user selects a link of any one of the web pages from among the search results, the web page corresponding to the selected link is displayed. At this time, the user terminal 3 transmits a URL of the web page corresponding to the selected link and a user ID to the online shopping mall server 3 according to the tool bar program. The online shopping mall server 3 registers a browsing history including the received URL and user ID in the browsing history DB 3b.

### REFERENCE SIGNS LIST

1 Advertisement providing server
2 Information providing server
3 Online shopping mall server
3a Sale item information DB
3b Browsing history DB
4 Web search server
5 Member information server
5a Member information DB
6 User terminal
11 Communication unit
12 Storage unit
12a Advertisement DB
12b Click history DB
12c Success history DB
13 Input/output interface
14 System control unit
14a CPU
14b ROM
14c RAM
15 System bus
141 Advertisement request acquisition unit
142 Advertisement-requesting user history acquisition unit
143 Number-of-histories-determining unit
144 Different person user ID acquisition unit
145 Different user history acquisition unit
146 Advertisement selection unit
147 Advertisement transmission unit
148 Tendency degree calculation unit
NW, NL Network
S Information processing system

1. An information processing apparatus comprising:
a transmission request acquisition means that acquires a transmission request including page identification information identifying a web page being browsed and user identification information identifying a requesting user who requests a transmission of an advertisement;
a number acquisition means that acquires a number of histories of a predetermined action of the user corresponding to the acquired user identification information identifying the requesting user from a history storage means storing page identification information identifying a web page at least browsed in association with user identification information identifying a user;
a user identification information acquisition means that when the number of histories of the predetermined action of the user that is acquired by the number acquisition means is smaller than a threshold value, acquires user identification information of a different user who is different from the user and whose history includes the page identification information included in the transmission request from the history storage means;
an action history acquisition means that acquires a history of a predetermined action of the different user, the history including user identification information of the different user from the history storage means; and
an advertisement determination means that determines the advertisement on the basis of the history of the predetermined action of the different user that is acquired by the action history acquisition means.

2. The information processing apparatus according to claim 1, wherein
the action history acquisition means acquires the histories including user identification information of a user, among the different users, whose histories a number of which is greater than or equal to a predetermined number are stored in the history storage means.

3. The information processing apparatus according to claim 1, wherein
the user identification information acquisition means acquires the user identification information, from among user identification information of the different users whose histories include the page identification information included in the transmission request, corresponding to a browsing time included in a predetermined range of time from a current point in time from the history storage means storing the page identification information, the user identification information, and a browsing time of the web page in association with each other.

4. The information processing apparatus according to claim 1, wherein
the user identification information acquisition means acquires user identification information of the different user whose history includes the page identification information included in the transmission request and a browsing time from the history storage means storing the page identification information, the user identification information, and a browsing time of the web page in association with each other, and
the action history acquisition means acquires a predetermined number of histories in order of closeness of browsing times in histories including user identification information of the different user to the browsing time acquired by the user identification information acquisition means.

5. The information processing apparatus according to claim 1, wherein
the user identification information acquisition means acquires user identification information of the different user whose history includes the page identification information included in the transmission request and a browsing time from the history storage means storing the page identification information, the user identification information, and a browsing time of the web page in association with each other, and
the action history acquisition means acquires the history including the browsing time included in a predetermined range of time from the browsing time acquired by the user identification information acquisition means from among the histories including user identification information of the different user.

6. The information processing apparatus according to claim 1, wherein
the user identification information acquisition means acquires user identification information of the different user whose history includes the page identification information included in the transmission request and a word from the history storage means storing the page identification information, the user identification information, and a word used when the browsed web page is searched for in association with each other, and
the action history acquisition means acquires the history including the word acquired by the user identification information acquisition means from among the histories including user identification information of the different user.

7. The information processing apparatus according to claim 1, wherein
the advertisement determination means determines the advertisement on the basis of the histories acquired by the action history acquisition means when the number acquired by the number acquisition means is smaller than the threshold value and a number of the histories acquired by the action history acquisition means is greater than or equal to a predetermined number.

8. The information processing apparatus according to claim 1, wherein
the action history acquisition means acquires the histories including user identification information of different users from the history storage means storing histories including the user identification information and division identification information identifying a division to which a transaction target that is a target of the predetermined action belongs,
the information processing apparatus further includes a calculation means that calculates a degree of tendency to do the predetermined action toward any of one or more divisions indicated by the division identification information included in one or more histories acquired by the action history acquisition means, and
the advertisement determination means determines the advertisement on the basis of the histories acquired by the action history acquisition means when the number acquired by the number acquisition means is smaller than the threshold value and the degree of tendency that is calculated by the calculation means is greater than or equal to a second threshold value.

9. The information processing apparatus according to claim 8, further comprising:
a second threshold value determination means that determines the second threshold value such that the smaller a number of the histories acquired by the action history acquisition means is, the smaller the second threshold value is,
wherein the advertisement determination means determines the advertisement on the basis of the histories acquired by the action history acquisition means when the number acquired by the number acquisition means is smaller than the threshold value and the degree of tendency that is calculated by the calculation means is greater than or equal to the second threshold value determined by the second threshold value determination means.

10. The information processing apparatus according to claim 1, wherein
the action history acquisition means acquires histories including user identification information of the different users from the history storage means storing histories including the user identification information and division identification information identifying a division to which a transaction target that is a target of the predetermined action belongs,
the information processing apparatus further includes
a calculation means that calculates a degree of tendency to do the predetermined action toward any of one or more divisions indicated by the division identification information included in one or more histories acquired by the action history acquisition means, and
a threshold determination means that determines the threshold value such that the larger the degree of tendency that is calculated by the calculation means is, the larger the threshold value is, and
the advertisement determination means determines the advertisement on the basis of the histories acquired by the action history acquisition means when the number acquired by the number acquisition means is smaller than the threshold value determined by the threshold determination means.

11. The information processing apparatus according to claim 1, wherein
the action history acquisition means acquires the history including user identification information of the different user from the history storage means storing the history of a user's action toward a transmitted advertisement.

12. An information processing method performed by a computer, the method comprising:
a transmission request acquisition step of acquiring a transmission request including page identification information identifying a web page being browsed and user identification information identifying a requesting user who requests a transmission of an advertisement;
a number acquisition step of acquiring a number of histories of a predetermined action of the user corresponding to the acquired user identification information identifying the requesting user from a history storage means storing page identification information identifying a web page at least browsed in association with user identification information identifying a user;
a user identification information acquisition step of when the number of histories of the predetermined action of the user that is acquired by the number acquisition step is smaller than a threshold value, acquiring user identification information of a different user who is different from the user and whose history includes the page identification information included in the transmission request from the history storage means;
an action history acquisition step of acquiring a history of a predetermined action of the different user, the history including user identification information of the different user from the history storage means; and
an advertisement determination step of determining the advertisement on the basis of the history of the predetermined action of the different user that is acquired in the action history acquisition step.

13. (canceled)
